(19) United States
(12) Patent Application Publication
(10) Pub. No.: US 2010/0183199 A1
(43) Pub. Date: Jul. 22, 2010

(54) SYSTEMS AND METHODS FOR BIOMETRIC IDENTIFICATION

(75) Inventors: Evan R Smith, Chantilly, VA (US); Hsiang-Yi Yu, Chantilly, VA (US); Joseph C Bahler, Chantilly, VA (US)

Correspondence Address: Evan Smith;Eye Controls, LLC, 14158-J Willard Rd, Chantilly, VA, 20151, US

(73) Assignee: EYE CONTROLS, LLC, Chantilly, VA (US)

(21) Appl. No.: 12/665,036

(22) PCT Filed: Sep. 29, 2008
(86) PCT No.: PCT/US08/78190

§ 371 Date: Dec. 17, 2009

Related U.S. Application Data
(60) Provisional application No. 60/976,019, filed on Sep. 28, 2007.

(51) Int. Cl. G06K 9/00; G06Q 50/00; G06Q 10/00; G06F 17/30

(52) U.S. Cl. 382/117; 705/3; 705/2; 707/769; 707/E17.014

(57) ABSTRACT

An automated method of performing various processes and procedures includes central and/or distributed iris identification database servers that can be accessed by various stations. Each station may be equipped with a handheld staff-operated iris camera and software that can query the server to determine whether an iris image captured by the iris camera matches a person enrolled in the system. The station takes selective action depending on the identification of the person. In disclosed medical applications, the station may validate insurance coverage, locate and display a medical record, identify a procedure to be performed, verify medication to be administered, permit entry of additional information, history, diagnoses, vital signs, etc. into the patient's record, and for staff members may permit access to a secure area, permit access to computer functions, provide access to narcotics and other pharmaceuticals, enable activation of secured and potentially dangerous equipment, and other functions.

### TECHNICAL FIELD

The present invention is directed generally to the field of identifying persons in various environments, for example, health care environments.

### BACKGROUND ART

The need to maintain privacy of medical records has been widely discussed and has been the subject of government regulation, such as the U.S. Federal HIPAA legislation. There is a need for accurate identification of doctors, nurses and other staff persons accessing medical records and other critical electronic functions, and a need to ensure that a record obtained for a patient is the correct record, rather than the record of another patient. Staff identification is also essential for other purposes, for example, access to buildings, treatment areas, and other controlled locations, access to equipment, and access to narcotics and other pharmaceuticals.

Similarly, there is a need to accurately identify a patient at various stages of treatment, such as before beginning a procedure, when administering medication, for insurance purposes or upon admission or release of the patient. Despite efforts to identify patients using bar codes and other tokens attached to or associated with the patient, there remains a substantial error rate in the medical field for administering the wrong treatment or wrong medication to a patient. Implantation of radio frequency identification devices into patients has also been proposed. This concept meets with substantial resistance because of the perception (perhaps correct) that these devices could also be used for less benign purposes such as locating and tracking people.

Identification errors occur for many reasons in an office, clinical or hospital setting. Some patients may intentionally impersonate another person to obtain treatment under that person's insurance benefits. Other patients are unable to communicate their own identity, either due to a medical condition, language barriers, dementia, or because they are not old enough to speak (for example, newborn babies). Data entry errors, attachment of incorrect wristbands, and other human errors also cause misidentification and erroneous treatment.

Increasing use of electronic health records, and the development of Regional Health Information Organizations (RHIOs) or Health Information Exchanges (HIEs) to facilitate wide area access to electronic health records, makes accurate patient identification even more critical. Such systems typically assign a unique identifying number to patients and the record can be retrieved using that number, or by name and birth date. However, there is a substantial possibility of error in selecting patient records in this manner. The more records that are accessible in the system, the more likelihood that there will be multiple records with similar identifying characteristics such as name and birth date.

The need to accurately identify a person is not limited to the medical field. Accurate identification of armed forces personnel, enemy combatants, prisoners, and civilian populations during military operations and occupations is essential. Accurate identification of prisoners (both in civilian and combat settings) for movement control and release purposes is similarly essential. There is a general need in many businesses to identify customers for credit, payment, or accounting purposes. There is also a need to identify employees for access to computer systems, cash registers, secured areas, and various other purposes. Further, while much of the white collar population is now paid electronically, laborers in various fields are often paid with cash or checks on a weekly or daily basis, and accurate identification of the person picking up a paycheck is important in these cases.

There is growing recognition that biometric identification offers an alternative to token-based identification that has the potential of being more accurate when used to identify an inherent, unchanging, and distinctive characteristic of the person. The pattern of the human iris is one such unique identifier. Iris identification is one of the most accurate biometrics, as exemplified by U.S. Pat. No. 4,641,349 to Flom and Safir, which disclosed the concept of iris identification, and U.S. Pat. No. 5,291,560 to John Daugman, Ph.D., OBE, the pioneering mathematician who made iris-based identification possible by creating the first functional algorithm for this purpose.

For various reasons the health care industry and commercial industry in general have not substantially benefited from this technology. Companies developing applications for iris recognition technology have not studied existing health care processes and developed applications that allow simplification of those processes. Similarly, those skilled in the art have not redesigned existing health care processes and tailored iris identification applications to create new and improved iris-enabled processes.

Camera design and availability is also a barrier to adoption of iris recognition technology in many applications. Most iris identification systems heretofore have been designed for identification of persons who are trained to be recognized by the system and present themselves to a camera in an effort to be identified. These systems work well in cases where the person regularly uses the system and wants to be identified. As an example, iris identification systems have been installed in airports for fast-tracking frequent travelers. The travelers cooperate in this identification process to bypass queues where manual document inspection processes are performed. Typically these systems use a fixed-location camera and work well when the passengers cooperate by presenting themselves correctly to the camera. Various single eye and two-eye camera systems have been designed in an effort to reduce the presentation effort required from the passenger, by automatically obtaining iris images over a wide range of positions and ranges from the camera. These efforts have resulted in varying degrees of success at the expense of greater complexity and cost, and have not resulted in any clearly optimal solutions.

Many iris identification systems use complex camera systems that cannot be widely deployed due to cost considerations. The development efforts of the established iris camera industry, represented by LG of Korea, and Oki and Panasonic of Japan, appear to be entirely directed toward the development of more complex cameras designed for unattended, extremely high security applications. In fact, these manufacturers have stopped offering previous, less sophisticated single eye camera models in favor of sophisticated devices that simultaneously capture facial images and images of both eyes. At a cost of US$3,000 to $4,000 per camera, these cameras cannot be installed in a cost-effective manner at each patient contact location in a medical facility. The inventors have determined that there is a need for a different paradigm of camera design that makes it give virtually every computer in a medical facility the capability of accurately identifying patients and accessing their medical records.

A few cameras with somewhat lower cost have been manufactured, but the designs to date have not been easy to use. For example, Iridian Technologies (formerly of New Jersey) sold a web-cam type camera for iris recognition, and two Japanese companies, Panasonic and Oki, have developed low-cost cameras designed for self-identification. As another example, an Oki camera design is shown in U.S. Pat. No. 6,850,631. U.S. Pat. No. 6,309,069 to Seal et al. discloses a handheld camera that uses a hot mirror to allow a person seeking identification to self-orient the camera by viewing an LCD display inside the camera, while an infrared image is captured by a CCD device. However, like the other cameras, the Seal et al. camera requires cooperation and manipulation of the camera by the person to be identified.

The user interface for these cameras, designed to be held by the identification subject, generally requires accurate positioning of the camera at a specific distance from the eye, and use of the camera typically requires skill on the part of the person to be identified that must be acquired through training and practice.

Securimetrics, Inc. of Martinez, Calif. offers a portable, handheld computerized identification system incorporating an iris camera. This device can be used as a standalone portable system or tethered to a PC for identification of larger numbers of people. The Securimetrics product, however, is costly and has been used primarily in military and government applications.

Thus, the iris identification systems and cameras developed to date have not been successful in providing a system that is inexpensive yet easy to use in a number of specific identification scenarios. Among other deficiencies, as far as the inventors are aware, none of the existing cameras provide an inexpensive camera that can be easily used by a staff member to identify a customer, patient, or other person while requiring little or no active cooperative by the person to be identified.

The inventors thus believe there is a need for improved iris identification systems, improved health care processes incorporating iris identification, and for improved cameras useful in iris identification systems.

### DISCLOSURE OF INVENTION

It is to be understood that both the following summary disclosure and the detailed description are exemplary and explanatory and are intended to provide examples of the invention as claimed. Neither the summary disclosure nor the description that follows is intended to define or limit the scope of the invention to the particular features mentioned in the summary or in the description.

In an exemplary embodiment, an automated method of performing various processes and procedures includes central and/or distributed iris identification database servers that can be accessed by various stations. In this embodiment, each station is equipped with an iris camera, and software that can query the server to determine whether an iris image captured by the iris camera matches a person enrolled in the system. The station takes selective action depending on the identification of the person.

In some embodiments, the automated process is applied specifically to medical processes and procedures. In the case of patients, upon identification the station may validate insurance coverage, locate and display a medical record, identify a procedure to be performed, verify medication to be administered, or permit entry of additional information, history, diagnoses, vital signs, etc. into the patient's record. In many cases, traditional procedures may be redesigned, simplified, and expedited where a specially tailored iris identification system is provided.

In the case of staff members, upon identification the station may permit access to a secure area, permit access to computer functions such as patient record access, prescription and orders entry and other functions, provide access to narcotics and other pharmaceuticals, enable activation of secured and potentially dangerous equipment such as X-ray machines, or perform other functions based on validation of the staff member identity.

In certain embodiments, a handheld camera system provided at the station is aimed at the patient or staff eye by the staff member to capture the image. A viewfinder or display screen may be provided to assist in aiming and positioning the camera. Further, the camera and system may have dual functionality, performing iris identifications and reading barcodes with the same unit.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

### BRIEF DESCRIPTION OF DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is a flow chart showing an exemplary embodiment of an iris identification process;

FIG. 2 is a block schematic diagram of an exemplary embodiment of an iris identification system integrated into a medical environment;

FIG. 3a is a flow chart showing an exemplary embodiment of a patient medication process incorporating iris identification;

FIG. 3b is a flow chart showing an exemplary embodiment of a patient check process incorporating iris identification;

FIG. 4 is a block schematic diagram of an exemplary embodiment of a computer system used to implement the disclosed systems and processes;

FIG. 5a is a plan view of an exemplary embodiment of an iris identification camera;

FIG. 5b is a block schematic diagram of an exemplary circuit for the camera of FIG. 5a;

FIG. 6a is a plan view of an additional exemplary embodiment of an iris identification camera;

FIG. 6b is a block schematic circuit diagram of an exemplary operating circuit for the camera of FIG. 6a;

FIG. 7a is a perspective view of an exemplary embodiment of an integrated handheld device comprising a computing device, an iris identification camera, and optionally a bar code, proximity or RF ID reader;

FIG. 7b is a side view of the embodiment of FIG. 7a;

FIG. 8a is a perspective view of an exemplary embodiment of a portable iris identification camera configured as an attachment for a handheld computing device; and

FIG. 8b is a cutaway view of the camera of FIG. 8a further showing a block schematic diagram for circuits in the camera.

FIG. 9 is a block schematic diagram of a further exemplary embodiment of a portable iris identification camera;

FIG. 10 is a diagram showing a method of dividing the camera's field of view into smaller windows for analysis;

FIG. 11a shows a further exemplary embodiment of a portable iris identification camera;

FIG. 11b shows another exemplary embodiment of a portable iris identification camera;

FIG. 12 is a block schematic diagram of a preferred embodiment of a portable iris identification camera;

FIG. 13a is a front view of the camera of FIG. 12;

FIG. 13b is a side sectional view of the camera of FIGS. 12 and 13a;

FIG. 13c is a side view of the camera of FIGS. 12-13;

FIG. 14 is a block schematic diagram of an exemplary software arrangement for one preferred embodiment of an iris identification system;

FIG. 15 is a flow chart showing an exemplary process for operating a multifunctional camera to perform iris identification and barcode reading functions; and

FIGS. 16a-b are illustrations of screen displays used in setup of an exemplary embodiment of a universal software interface.

### MODES FOR CARRYING OUT THE INVENTION

The present invention will be described in terms of one or more examples, with reference to the accompanying drawings. In the drawings, some like reference numbers indicate identical or functionally similar elements. Additionally, the left-most digit(s) of most reference numbers may identify the drawing in which the reference numbers first appear.

The present invention will be explained in terms of exemplary embodiments. This specification discloses one or more embodiments that incorporate the features of this invention. The disclosure herein will provide examples of embodiments, including examples of data analysis from which those skilled in the art will appreciate various novel approaches and features developed by the inventors. These various novel approaches and features, as they may appear herein, may be used individually, or in combination with each other as desired.

In particular, the embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, persons skilled in the art may effect such feature, structure, or characteristic in connection with other embodiments whether or not explicitly described.

Embodiments of the invention may be implemented in hardware, firmware, software, or any combination thereof, or may be implemented without automated computing equipment. Embodiments of the invention may also be implemented as instructions stored on a machine-readable medium, which may be read and executed by one or more processors. A machine-readable medium may include any mechanism for storing or transmitting information in a form readable by a machine (e.g. a computing device). For example, a machine-readable medium may include read only memory (ROM); random access memory (RAM); hardware memory in handheld computers, PDAs, mobile telephones, and other portable devices; magnetic disk storage media; optical storage media; thumb drives and other flash memory devices; electrical, optical, acoustical, or other forms of propagated signals (e.g. carrier waves, infrared signals, digital signals, analog signals, etc.), and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

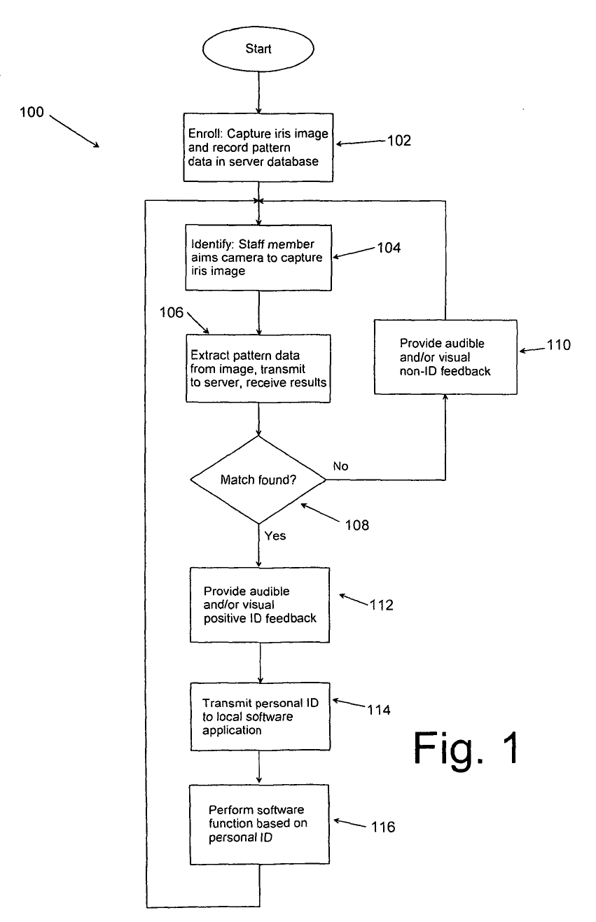

FIG. 1 is a flow chart showing an exemplary embodiment of an iris identification process. The process starts at step 102, where an iris image is captured at an enrollment location. The image is converted to an iris pattern template using an iris algorithm, such as the algorithm disclosed in U.S. Pat. No. 5,291,560 to Daugman or algorithms available from Iritech, Inc. of Fairfax, Va. The iris pattern template is then transmitted to a server and stored in a database of iris pattern templates. In another embodiment, the iris pattern template may be stored on a local computer or on a token, such as a smart card, passport, or other identification item. When a server is used, various server configurations may be provided depending on parameters of the application, including the locations to be served, available communications networks, size of the database required, the rate and number of identifications to be performed, security and privacy considerations, and other relevant factors. For example, a single central server may be provided, or servers may be distributed to serve different locations, regions, or subject groups or populations. Backup servers may be provided, and more than one server may be provided in the same or different locations to enhance capacity. In addition, when large databases are employed, multiple servers or processors can be operated in parallel, each attempting to match the received template to a portion of the database records. Due to the accuracy of available iris recognition algorithms, only one server will produce a match if the database contains a matching record. In cases where more than one server is used, server databases may be updated online or periodically using batches using known database record updating techniques.

In the biometric field, the term “identification” is sometimes used to mean a process where an individual identity is determined by a one-to-many database search. The term “verification” is sometimes used to refer to a process of one-to-one matching. In this specification, each of the terms “identification” and “verification” are intended to encompass both possibilities. For example, when the term “identification” is used, it should be understood that this term may refer to identification and/or verification, and when the term “verification” is used, it should be understood that identification may be included within the scope of verification.

Once enrolled, the person can be identified at any later time as exemplified by the continuing process beginning at step 104. In a preferred embodiment, a staff member aims a handheld camera at the person to be identified to capture a real time iris image. For example, this step may use a wired or wireless camera connected to a local computer, such as the exemplary camera designs shown and described herein. However, the process described is not limited to the cameras described herein and will work with any camera that provides an acceptable iris image, including iris cameras that are commercially available and designs that are developed in the future. The required pixel dimensions and characteristics of the iris image are determined by the iris algorithm selected for use in the process.

In step 106, iris pattern data is extracted from the image and transmitted to the server for matching. A matching algorithm compatible with the iris template generating algorithm used in steps 102 and 104 is executed in the server to locate a matching record. In another embodiment of step 106, the raw image data is sent to the server or other computer device that will perform the matching operation, and processed entirely at the server. In this case, the server or other computer device extracts pattern data from the image and performs the matching operation by comparing the extracted pattern data to stored templates. In a further embodiment, if the system is designed to store templates on tokens or in local databases, a one-to-one or one-to-many match may be performed at the camera location.

In some embodiments, data in addition to image or pattern data may be transmitted to the server for processing. For example, proposed financial transaction data such as a credit authorization request may be transmitted along with the image or pattern data to be used for identification. In other embodiments, a request for specific information or access to a specific location may be transmitted with the pattern or image data. This information may be transmitted as a separate data element, or in the form of an identification code for the transmitting location that implies a standard process to be performed. For example, if a transmitting location comprises a camera mounted next to a secure door, and if this location identifies itself to the server and sends pattern or image data for processing, the server may automatically interpret the transmission as a request by the person whose iris image has been captured for access through the secure door.

The computer performing the matching operation (regardless of whether it is a local computing device or a server located at any desired location) will typically provide results to the device that requested an identification. The results may be received in any convenient form. In one embodiment, the database has a record key for each iris record, and returns a failure code if no match is found, and the record key of the match if a match is made. The station where the person is to be identified can then use the record key to perform further functions. In another embodiment, the database may contain additional information about the person to be identified and selected information items may be returned to the identification station, such as data displaying the person's name, or providing authorization to enter a particular location.

At step 108, the results received from the matching engine are reviewed and, in the embodiment shown, a different function is performed based on whether a match was found. If the person has been identified, the process continues at step 112. If no match was found, the process continues at step 110 where feedback is provided to the operator. Feedback may be in any human perceptible form, such as for example a visual, audible, or audiovisual cue. As an example, a failure of identification can be indicated to the operator by a series of tones or a long continuous tone generated from a speaker or other sound generating device in the computer connected to the iris camera. As another example, an identification failure can be indicated by a visual display on the screen of the computer connected to the iris camera, on a screen associated with the camera device itself, or using a visual indicator such as a red light emitting diode. The process then continues at step 104, and the unit resets itself for another attempt to identify the same person or another person, as needed.

In step 112, human-perceptible feedback is provided to indicate that a match was made. This feedback is preferably different from the feedback provided in step 110 when no match is made. For example, audible feedback might include a single short beep or a distinctive pattern of beeps from a system speaker of the computer attached to the iris camera. Visual feedback may also be provided if desired, such as a display of information on the screen of the computer, on a screen associated with the camera device, or using a green LED on the camera device.

In step 114, the process may optionally use identification information received from the server in step 106 to perform a function using another software application, such as another application operating in the same computer device. As an example, in a medical patient identification process, the patient may be identified by the iris recognition process described previously, and a unique patient identifier or “record key” may be returned by the server. Preferably this record key is the same as the record key used for the same patient by at least one other software application used by the facility.

The local station may use information received, such as a record key, to perform patient-specific functions using another available application, as shown in step 116. In the example given above of a patient identification process, the record key may be transmitted to an electronic medical records system, scheduling system, practice management system, or other application that can perform a function based on the patient's unique ID. For example, the patient's appointment record, billing records, or medical charts may be displayed in response to the transmission of the record key to one of these other available applications.

The record key may be transferred from the iris identification application to another application using any method. As examples, information may be transferred from one program to the other using the keyboard buffer, by analyzing the screen display of the computer and filling an input location with the patient record key, by generating an interrupt or other indicator to the other application that new identification data is available, or by having the application call the iris identification application as a subroutine and by returning the record key and any other information of interest in response to the subroutine call.

After the iris identification process provides information to the other application as desired, the process continues at step 104 and the system is reset to perform another identification process.

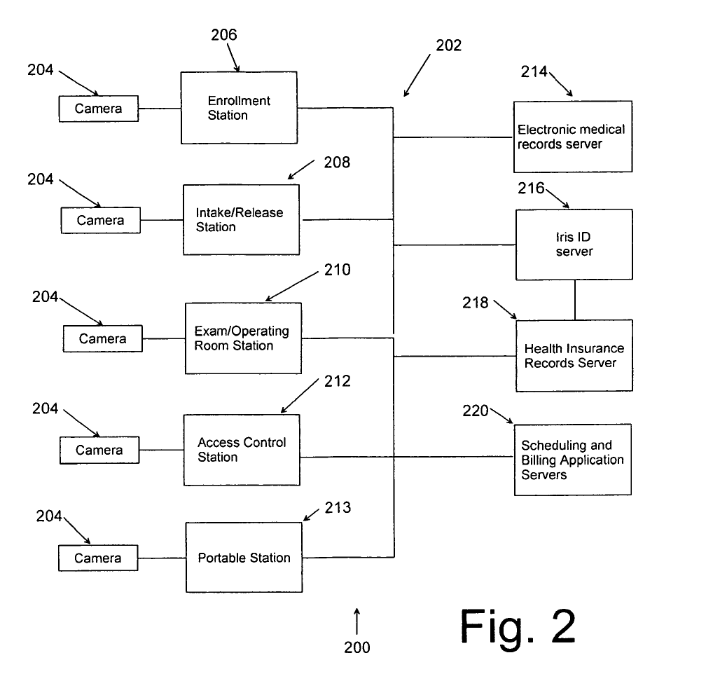

FIG. 2 is a block schematic diagram of an exemplary embodiment of a novel iris identification system integrated into a medical network to provide new patient service capabilities. This system may be used, for example, to implement various process embodiments disclosed with reference to FIG. 1 and the other figures herein.

Referring now to FIG. 2, a system 200 comprises a network 202 connecting an electronic medical records server 214, an iris ID server 216, a health insurance records server 218, and scheduling and billing applications servers 220. Also connected to network 202 are enrollment station 206, intake/release station 208, exam/operating room station 210, access control station 212, and portable station 213. Enrollment station 206, intake/release station 208, exam/operating room station 210, access control station 212 and portable station 213 are each equipped with a camera 204 that captures iris images. The diagram of FIG. 2 is merely an example of a system 200 of this type, and many variations are possible within the scope of the present invention. For simplicity, one of each type of station, computer, server and the like are shown connected to network 202. However, it will be understood that network 202 may include any desired number of stations, computers, or servers of each type, and may include large numbers of stations at patient care locations. Further, a system 200 may be designed to omit one or more elements shown in this exemplary embodiment. In addition, system 200 may include additional elements, devices, or systems not shown in this example, as desired, to provide additional functions consistent with the process and hardware descriptions herein.

Enrollment station 206 is an example of a station configured to provide biometric enrollment functions for patients and/or other users of system 200. Enrollment station 206 may be dedicated to enrollment functions or this function may be combined with any other device, such as any other device shown in FIG. 2.

Intake/release station 208 is a computer located at a place where patient intake occurs, such as at a clinic or hospital, or where patients are discharged, or both. Intake/release station 208 performs patient identification and provides an interface between the identification system and applications that are required for patient intake or release, such as scheduling applications, patient record storage applications, insurance verification applications, and/or billing applications.

The systems and processes disclosed herein have particularly advantageous applications in the area of insurance validation, verification, and claims automation. Rather than rely on a manual system of reviewing insurance cards, verifying coverage, and submitting claims, the patient can be positively identified at the time of intake at a doctor's office, clinic, or hospital. The patient's insurance company, or a group of insurance companies, may maintain an iris ID server such as server 216 for the purpose of identifying their subscribers. The insurance company can then arrange for appropriate ID verification and enrollment of its subscribers, and thereafter, subscribers can be easily identified and provided with access to services based on their iris pattern, rather than being required to present an insurance card. This method virtually eliminates the possibility of fraudulent use of another person's insurance card to obtain care.

Exam/operating room stations 210 are located at any place where patient care is administered, such as in examination rooms, treatment rooms, operating rooms, lab rooms, and other locations where patients may receive care and identification of the patient may be desired.

Access control stations 212 may be located at any place where access to an area is controlled. For example, doors or portals that lead to patient care areas, areas restricted to staff only, pharmacy areas, and the like may be provided with an access control station 212 and a camera 204 connected to a door control or release. When an authorized staff member presents his or her iris to camera 204 and is identified by access control station 212, the associated door control or release is activated and the staff member is allowed access to the secure area protected by access control station 212. This method may also be used as a safety measure to prevent unauthorized use of sensitive or dangerous equipment. Staff members may be provided with an access control station 212 and required to log in using iris identification before the station will allow them to activate sensitive equipment such as X-ray, MRI, and other imaging equipment.

In addition, system 200 may be used to control access to patient record storage, including both physical storage for paper records, and electronic access to electronic records. Staff members may be required to log in to an electronic medical records system or any other system by presenting their iris to a camera 204 and validating their identity. Different levels of access to patient records, including read only, read/write, and other levels of access, may be provided to different staff members based on their job requirements.

Biometric log in of staff members to provide access to various systems can be enabled at any computer station in a network, merely by adding a camera, software for performing identification functions using the camera, and an interface that provides the confirmed staff identification information to the application requiring a login. Similarly, positive identification of patients for various caregiving, record keeping, insurance verification and claims, scheduling, and billing purposes can be implemented in legacy health care automation systems merely by adding these components to stations where immediate and accurate patient identification will streamline or improve the process.

The various benefits and functions supported by iris identification can be added to an existing medical computer network merely by providing at least one central iris ID server 216 and retrofitting each station that will perform identifications with a low-cost camera such as camera 204 or camera 1200 and the driver and interface software described herein. In this way, the operation and security of existing medical data processing systems can be vastly improved. In many cases, improvements in patient processing and streamlined methods of care delivery are made possible by providing a ready capacity for instant, accurate identification of patients and/or staff members.

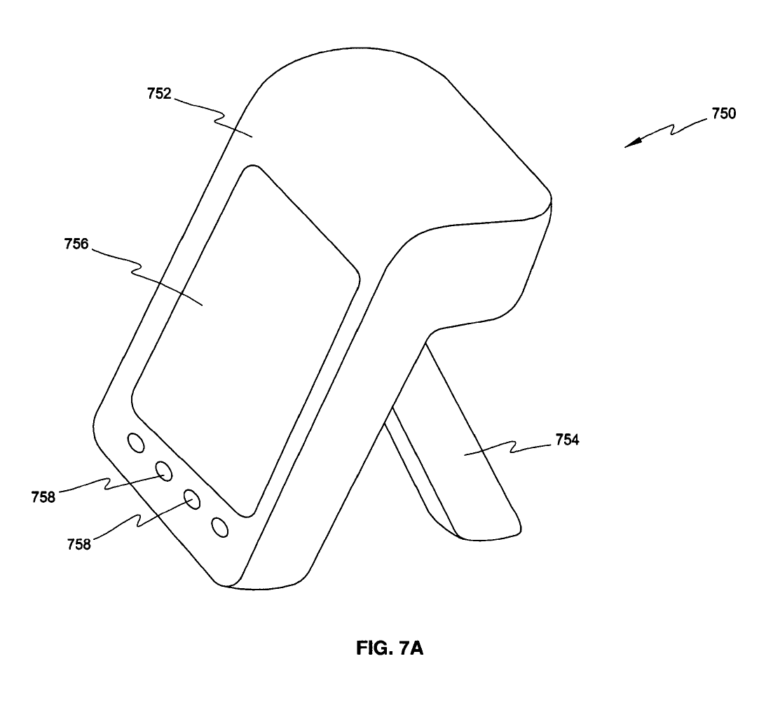

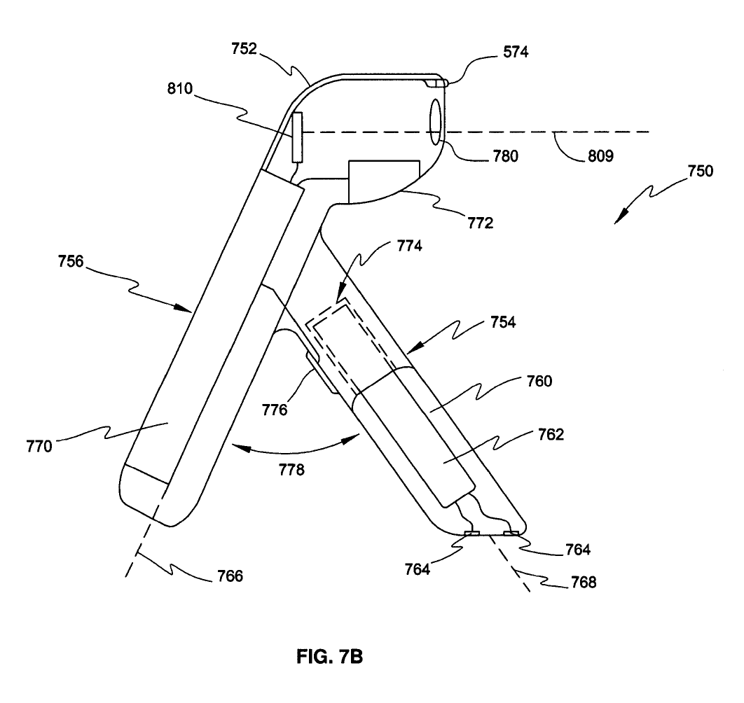

Portable stations 213, such as the example devices shown in FIGS. 7a, 7b, 8a and 8b, and 13a, 13b and 13c may be provided to staff members at a doctor's office, clinic, or hospital to facilitate portable identification of patients during caregiving procedures. These devices may communicate with network 202 directly or through a wireless device server (not shown). In addition to identifying patients, the portable units may perform other data retrieval, collection, and storage functions such as permitting portable entry, wireless transmission, and central storage of medication dosing records, vital signs, urinary and stool records, other items that are typically charted by staff during patient care, and any other patient information that is to be added to the patient's record, all from the patient's bedside or other patient location.

In other embodiments, the portable stations 213 may automatically retrieve medication and dosage instructions and display those instructions for the caregiver in direct response to identification of the patient by the portable station 213. In addition, if the portable stations 213 are equipped with sensors other than an iris image sensor, as described herein in the example embodiment of FIGS. 7a and 7b, they can be used to match a medication container to the patient. The medication container may be provided with a radio frequency identification (RF ID) tag, a bar code (including, for example, various two and three dimensional bar codes), a number or code to be matched to a code displayed on the device, or another identifying feature that will assist the caregiver in verifying that the medication about to be administered is the correct medication for the patient who has been positively identified by the system.

Upon completion of an iris identification of a patient or staff member, the iris camera driver software operating in the station may transfer identification information received from the server, such as a unique record key associated with the patient or staff member just identified, to another application operating in the same station or a station connected through network 202. That application, such as a medical records storage and retrieval application, an insurance verification or claims processing application, a scheduling application, or a billing application, can then access the appropriate record and perform a function desired by the staff member. Such an application may access the electronic medical records server 214, the health insurance records server 218, the scheduling and billing application servers 220, or any other application server connected to network 202 or to another network accessible from system 200.

Network 202 may be any desired network or combination of private and public networks, and may include the internet, local area networks, wide area networks, virtual private networks, and other network paths as desired.

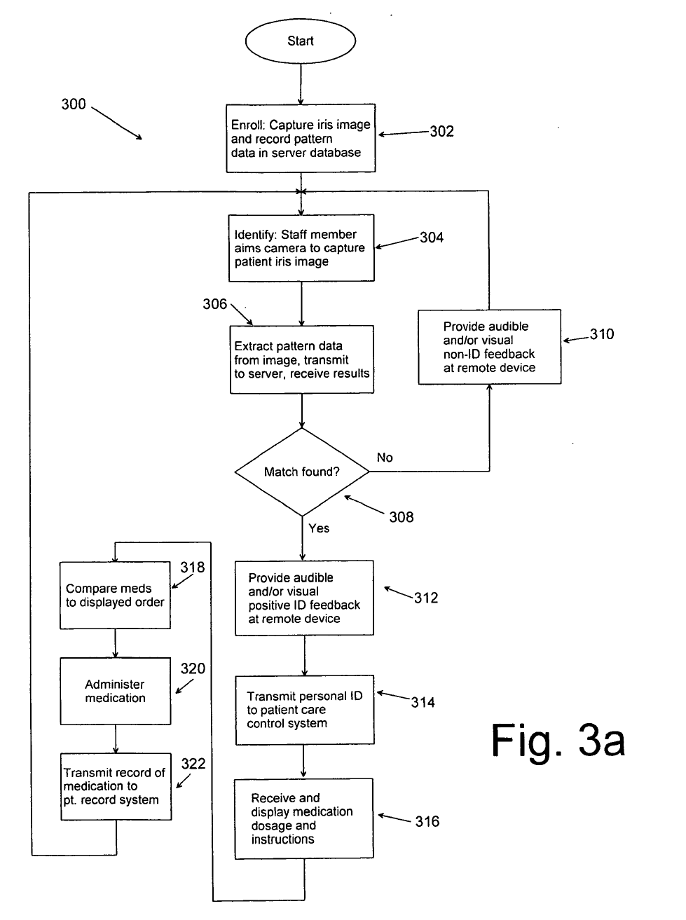

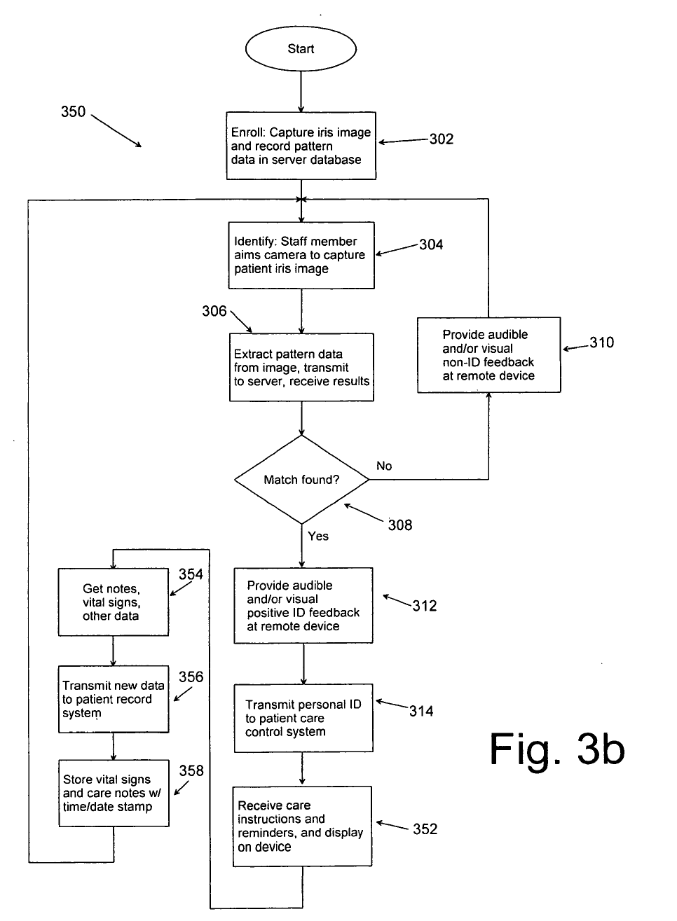

FIG. 3a is a flow chart showing an exemplary embodiment of a patient medication process incorporating an iris identification method. Operation begins at step 302 where the patient is enrolled by storing his iris pattern data in a database. Later, when medication is to be administered, starting at step 304 a staff member aims an iris camera at the patient to capture an iris image. In step 306 the iris pattern data is extracted and the patient is identified. In step 308, if a match is found, the process continues at step 312. If no match is found an indication is provided at step 310 and the process concludes for that patient and begins again at step 304.

In step 312, visual or audible feedback is provided at the camera to indicate that identification was successful. In step 314, the patient's unique identifier, received from the identification system, is provided to a medication management or patient care control application. The medication management application provides medication dosage and instructions in step 316. In step 318, the medication to be administered is compared to the order, which may be accomplished using barcode or RFID confirmation. If the medication is determined to be correct, it is administered in step 320. A record of medication delivery is transmitted to the patient record system in step 322. The staff member giving the medication is preferably logged in at the start of the medication process, so that when the process is complete, the system has recorded irrefutable evidence of (1) the identity of the staff member, (2) the identity of the patient, (3) the labeling of the medication, (4) confirmation of the match between patient and medication, and (5) the exact date and time of administration.

FIG. 3b is a flow chart showing an exemplary embodiment of a patient check process incorporating an iris identification method. Operation begins at step 302 where the patient is enrolled by storing his iris pattern data in a database. Later, when the patient is to be checked or other care provided, starting at step 304 a staff member aims an iris camera at the patient to capture an iris image. In step 306 the iris pattern data is extracted and the patient is identified. In step 308, if a match is found, the process continues at step 312. If no match is found an indication is provided at step 310 and the process concludes for that patient and begins again at step 304.

In step 312, visual or audible feedback is provided at the camera to indicate that identification was successful. In step 314, the patient's unique identifier, received from the identification system, is provided to a medical record system or other patient care control application. The patient care application provides care instructions and reminders in step 352. In step 354, vital signs, notes and other data are collected through examination of the patient and entered into a computing device. The new information is transmitted to the patient record system in step 356. The information is stored with a time and date stamp in step 358. The staff member giving care is preferably logged in at the start of the care process, so that when the process is complete, the system has recorded irrefutable evidence of (1) the identity of the staff member, (2) the identity of the patient, (3) the exact date and time the patient was checked.

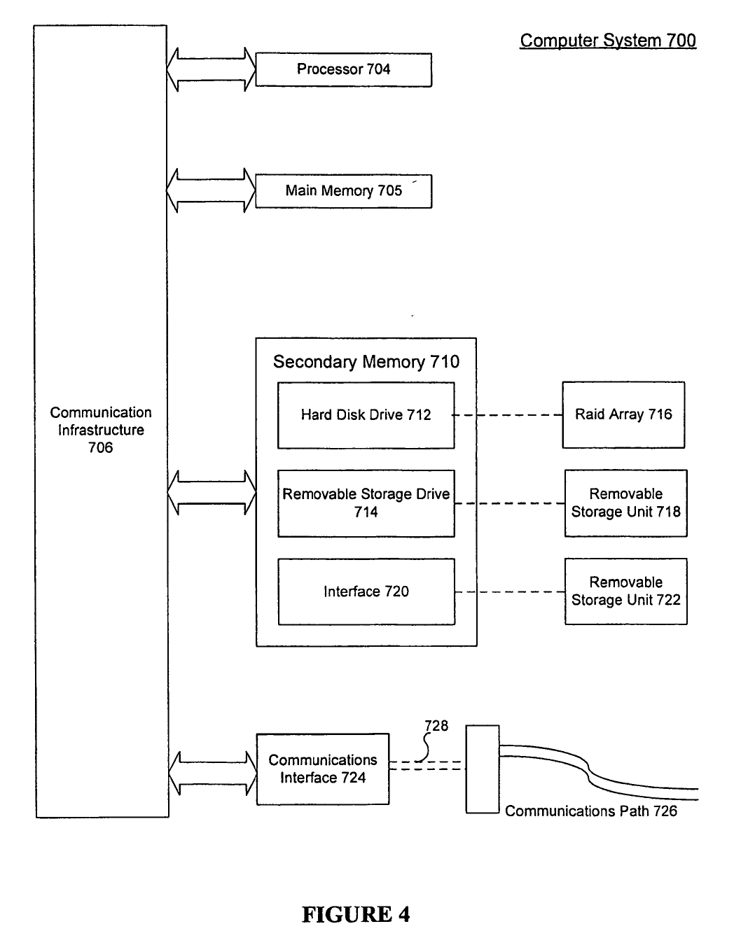

The following description of a general purpose computer system, such as a PC system, is provided as a non-limiting example of systems on which the disclosed analysis can be performed. In particular, the methods disclosed herein can be performed manually, implemented in hardware, or implemented as a combination of software and hardware. Consequently, desired features of the invention may be implemented in the environment of a computer system or other processing system. An example of such a computer system 700 is shown in FIG. 4. The computer system 700 includes one or more processors, such as processor 704. Processor 704 can be a special purpose or a general purpose digital signal processor. The processor 704 is connected to a communication infrastructure 706 (for example, a bus or network). Various software implementations are described in terms of this exemplary computer system. After reading this description, it will become apparent to a person skilled in the relevant art how to implement the invention using other computer systems and/or computer architectures.

Computer system 700 also includes a main memory 705, preferably random access memory (RAM), and may also include a secondary memory 710. The secondary memory 710 may include, for example, a hard disk drive 712, and/or a RAID array 716, and/or a removable storage drive 714, representing a floppy disk drive, a magnetic tape drive, an optical disk drive, USB port for a thumb drive, PC card slot, SD card slot for a flash memory, etc. The removable storage drive 714 reads from and/or writes to a removable storage unit 718 in a well known manner. Removable storage unit 718, represents a floppy disk, magnetic tape, magnetic drive, optical disk, thumb drive, flash memory device, etc. As will be appreciated, the removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a wireless network communications device such as an IEEE 802.11x wireless Ethernet device, a PCMCIA slot and card, etc. Software and data transferred via communications interface 724 are in the form of signals 728 which may be electronic, electromagnetic, optical or other signals capable of being received by communications interface 724. These signals 728 are provided to communications interface 724 via a communications path 726. Communications path 726 carries signals 728 and may be implemented using wire or cable, fiber optics, a phone line, a cellular phone link, an RF link and other present or future available communications channels.

The terms “computer program medium” and “computer usable medium” are used herein to generally refer to media such as removable storage drive 714, a hard disk installed in hard disk drive 712, and signals 728. These computer program products are means for providing software to computer system 700.

Computer programs (also called computer control logic) are stored in main memory 708 and/or secondary memory 710. Computer programs may also be received via communications interface 724. Such computer programs, when executed, enable the computer system 700 to implement the present invention as discussed herein. In particular, the computer programs, when executed, enable the processor 704 to implement the processes of the present invention. Where the invention is implemented using software, the software may be stored in a computer program product and loaded into computer system 700 using raid array 716, removable storage drive 714, hard drive 712 or communications interface 724.

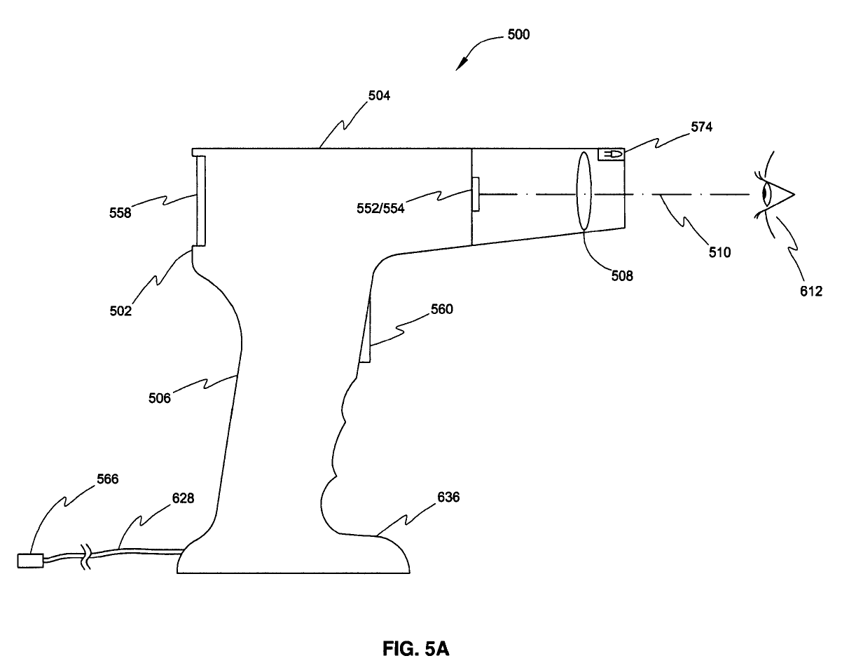

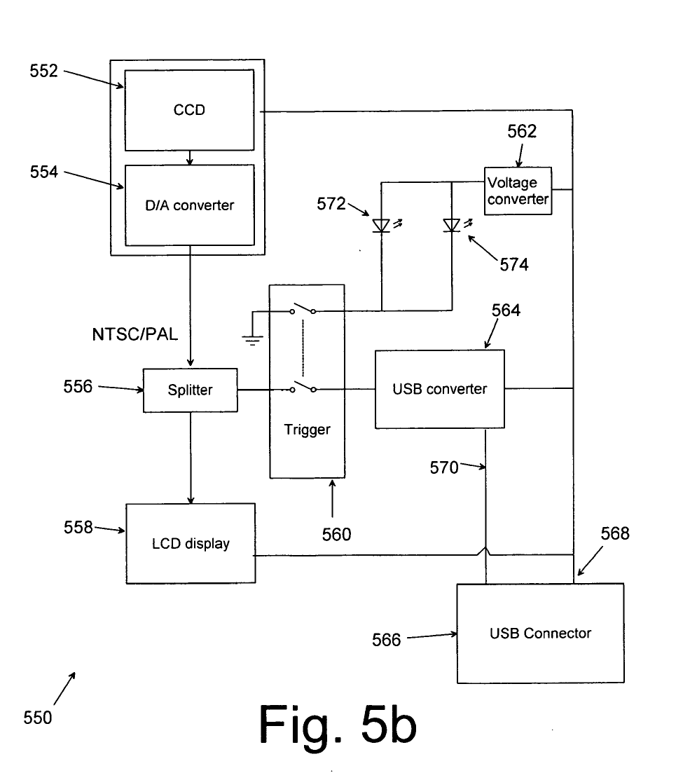

FIG. 5a is a plan view of an example embodiment of an iris identification camera. In this example, camera 500 comprises housing 502 having a barrel portion 504 and a grip portion 506. One or more optical elements 508 are mounted in barrel portion 504 along an optical axis 510 extending between CCD 552 and D/A converter 554 and a subject eye 612. One or more near-infrared LEDs 574 are mounted in barrel portion 504 so as to illuminate eye 612 for improved iris pattern imaging. An LCD display screen 558 is mounted at the rear of barrel portion 504. Preferably LCD display screen 558 is mounted activating the camera device. A base portion 636 is designed so that the camera 500 will balance in a rest position on base 636 when not in use. A connecting cable 628 and connector 566 are provided to connect camera 500 to a computing device.

Optical elements 508 may be a single lens, or a plurality of lenses and/or other optical elements in an optical assembly. Optical elements 508 preferably provide an in-focus image of eye 612 at CCD 552 over a generally wide focal range around a predetermined distance from eye 612. For example, the optical elements 508 may be designed to provide a well-focused image when the end of barrel portion 504 is about four inches from eye 612, with an in-focus range of plus or minus one inch. Alternatively, optical elements 508 may include a macro autofocusing lens array. CCD 552 is filtered as required to provide a near-infrared sensitive image capture. LCD display screen 558 displays the image output of CCD 552 to assist the user in aiming camera 500. To use camera 500, the operator holds the end of barrel portion 504 about four inches from the patient's eye and pulls the trigger 560. Trigger 560 activates LCD display 558 (or display 558 may be continuously active) and the operator may then adjust his aim so that eye 612 is centered in the image shown on LCD 558.

Connecting cable 628 may be any desired power and/or data cable. As an example, cable 628 may be a universal serial bus (USB) cable and connector 566 may be a standard USB connector. Other standard or nonstandard data cables may be used, including serial cables, printer port cables, and other cables. Alternatively, camera 500 may be battery operated and/or may use wireless data transmission to communicate with an associated computer device or station, eliminating the need for some or all of the cable connections. If a USB cable is used, under current USB standards the camera 500 may draw up to 0.5 A from the USB port. If more power is required, a y-cable may be used to connect power to two USB ports, making a total of nearly 1.0 A available to camera 500 without a separate power supply. A separate power supply may also be provided in some embodiments.

FIG. 5b is a block schematic diagram of an exemplary circuit 550 for camera 500 shown in FIG. 5a. In this example embodiment, circuit 550 comprises a connector 566 connected through power lines 568 to LCD display 558, USB converter 564, voltage converter 562, CCD 552, and D/A converter 554. Data lines 570 from connector 566 are connected to USB converter 564. A video output signal of CCD 552 is connected to D/A converter 554, which provides an NTSC or PAL output to splitter 556. Splitter 556 is connected to LCD display 558 which receives the NTSC or PAL output and displays the image data. Splitter 556 is also connected through trigger 560 to USB converter 564. When trigger 560 is activated the NTSC/PAL signal is transmitted through trigger 560 to USB converter 564, which transmits a USB serial data signal through USB connector 566 to a connecting computing device for processing.

Voltage converter 562 is connected (optionally) to general illumination LEDs 572 and to one or more IR LEDs 574. A secondary set of contacts in trigger 560 is connected to complete a circuit to actuate LEDs 572 and 574. General illumination LEDs 572, if installed, provide broad spectrum light directed generally toward eye 612 to aid in aiming the camera. IR LEDs 574 provide near infrared illumination to enhance iris pattern imaging.

Trigger 560, when actuated, turns on LEDs 572 and/or 574 to illuminate the target iris. Trigger 560 also closes a circuit to provide a video signal to USB converter 564. When there is no input signal to converter 564, the converter 564 will operate in an idle mode and will not generate video frames for transmission to a connected computing device. When the input signal reaches converter 564 due to activation of trigger 560, converter 564 will provide real time iris image frames to the connected computing device. Voltage converter 562 converts the USB voltage to a different voltage, if needed, for driving the LEDs 572 and 574 selected for use.

In one example operating method, as the operator holds the trigger down and moves the camera slowly through the fixed focus range, a series of iris image frames are captured and transmitted to the connected computing device. The computing device performs an algorithm to process the frames received, and testing those frames for focus value and the presence of a good iris image. When the image received meets predetermined criteria for focus and subject presence, the computing device may either send the image data to a server, or extract pattern data from the image and send it to the server. A number of images may be sent to the server in continuous fashion until the server has either returned a positive identification, or a predetermined time or number of images has elapsed without a positive match, in which case the system may indicate a failure to identify. The operator, if properly trained, may also be able to identify himself or herself by holding the camera at an approximately correct distance from his or her eye, looking into the end of the camera, and pulling the trigger.

The ergonomic arrangement of the LCD display 558, barrel portion 504, grip portion 506, and optical axis 510, in combination, provides a particularly easy to use and intuitive device for capturing iris images. Operators can be rapidly trained to capture good iris images using this device without experience or technical expertise.

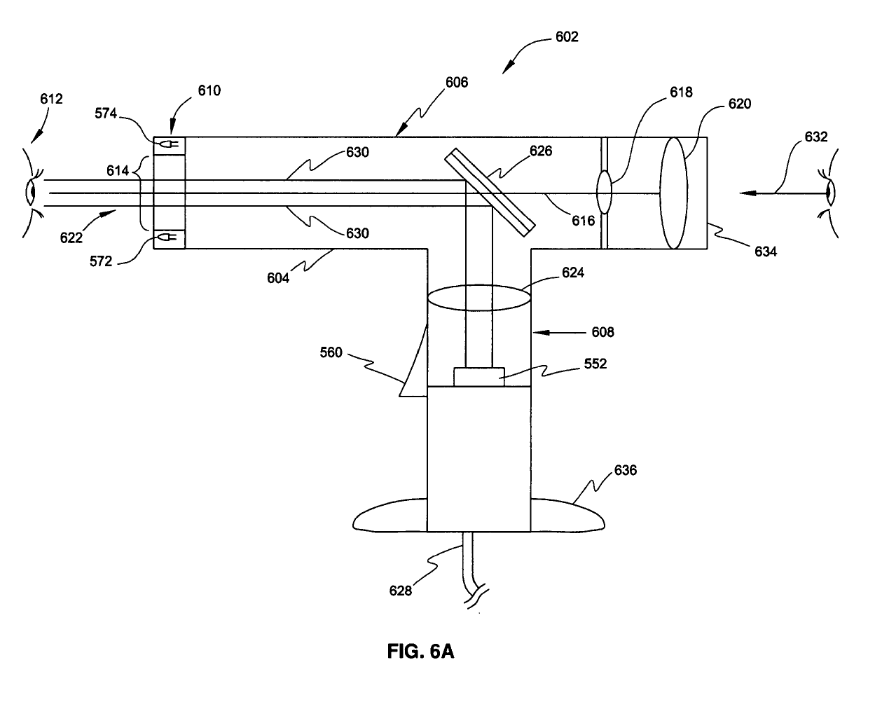

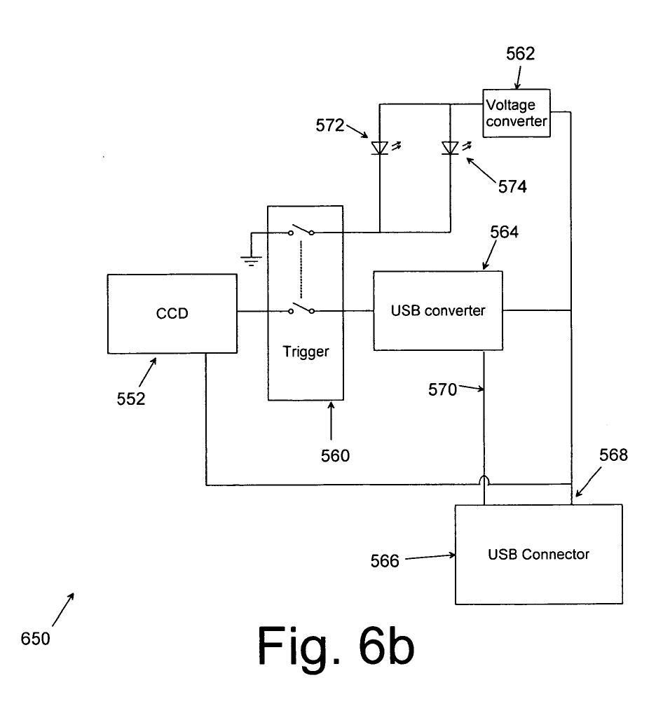

FIG. 6a is a plan view of an additional embodiment of an iris identification camera 602. In this example, camera 602 has a housing 606 including a barrel portion 604, a grip portion 608, and a base portion 636. An illumination ring 610 is located at an end 622 of barrel portion 604 that is aimed toward subject eye 612 along an optical axis 630. Illumination ring 610 may include general illuminating LEDs 572 and IR LEDs 574 similar to those described with reference to FIGS. 5a and 5b. A diffuser 614 spreads the light from LEDs 572 to avoid presenting bright point sources to the eye 612 that might result in discomfort to the subject of the identification attempt.

The optical path 630 extends between eye 612 and hot mirror 626, which is installed at a 45 degree angle to optical path 630 near the intersection of the barrel portion 604 and grip portion 608. Hot mirror 626 reflects infrared light at a 90 degree angle to the input and passes other wavelengths substantially unchanged through the mirror. Thus, infrared light along optical path 630 is reflected downward into grip portion 608 through (in this example) at least one optical element 624 to CCD 552. Optical element 624 may be a lens or a group of lenses and/or other optical elements. Optical element(s) 624 focus the image of eye 612 onto CCD 552 and may further filter the wavelength content of the light transmitted to CCD 552 to maximize the clarity of the resulting iris pattern image. Preferably the optical elements 624 provide an in-focus image through a broad range of distances between camera 602 and eye 612. For example, the focal range may be from 3 inches to 5 inches from eye 612.

Another optical path 616 extends along a central longitudinal axis of barrel portion 604 from eye 612 through end 622 to opposing end 634. Broadband light follows this path from eye 612, through hot mirror 626, and through one or more optical elements, such as viewfinder lens 618 and magnifying lens 620. The optical elements used will be selected to optimize the clarity and focus of an image of eye 612 provided at magnifying lens 620 by these elements.

In an operational embodiment, the operator of camera 602 depresses the trigger and moves camera 602 slowly through the fixed focus range of the camera. The operator uses his eye 632 to look at the magnifying lens 620, which displays an image of eye 612 along optical path 616. The operator uses this viewfinder image to ensure that eye 612 is centered in the viewfinder. This will also ensure that eye 612 is centered in the imaging space of CCD 552. Because of the configuration of the camera and its optical elements, the operator can use the viewfinder image effectively at fairly large distances from his own eye. Thus, it is not necessary for the operator to put his eye against camera 602. Preferably, the optical elements 618 and 620 are selected so that the image focus on magnifying lens 620 is the same as on CCD 552. In this way, the operator can judge the correct distance between the camera and eye 612 by observing the focus quality of the image on magnifying lens 620.

A series of iris image frames are captured and transmitted to the connected computing device. The computing device performs an algorithm to process the frames received, and testing those frames for focus value and the presence of a good iris image. When the image received meets predetermined criteria for focus and subject presence, the computing device may either send the image data to a server, or extract pattern data from the image and send it to the server. A number of images may be sent to the server in continuous fashion until the server has either returned a positive identification, or a predetermined time or number of images has elapsed without a positive match, in which case the system may indicate a failure to identify. The operator, if properly trained, may also be able to identify himself or herself by holding the camera at an approximately correct distance from his or her eye, looking into the end of the camera, and pulling the trigger.

An autofocus system may also be provided as part of optical elements 624. In this case, there will be a larger range of distances between camera 602 and eye 612 where a useful image can be captured. The viewfinder is used primarily for aiming in this case, rather than for focusing.

FIG. 6b is a block schematic circuit diagram of an exemplary operating circuit 650 for the camera of FIG. 6a. As can be seen by comparison with the example circuit of FIG. 5b, circuit 650 requires fewer electronic components and has reduced power requirements, as a result of the optical viewfinder feature of the camera in FIG. 6a. The optical viewfinder arrangement of this camera eliminates the need for an LCD viewfinder device and its associated circuitry. The elements shown having the same numbers as those in FIG. 5a have the same characteristics and functions in this diagram.

FIG. 7a is a perspective view of an exemplary embodiment of an integrated handheld device 750 comprising a computing device and an iris identification camera. In optional embodiments, this device may also include a mechanism for identifying other items, such as a bar code, proximity or RF ID reader. As shown in FIG. 7a, in this embodiment device 750 has a housing 752 incorporating a handheld computing device such as a PDA. The computing device has a touch screen display and control interface 756 and control buttons 758. A handle 754 is connected to housing 752 to enable the operator to hold the device 750 with ergonomic comfort in a position where it can capture iris images while the operator views the display 756.

FIG. 7b is a side sectional view of the device of FIG. 7a. As can be seen in the drawing figure, a computing device 770 such as a PDA is mounted in housing 752. Computing device 770 is able to run software for processing iris images collected by imaging device 810. Computing device 770 also includes a wireless networking capability, whereby the computing device 770 can exchange data with other devices and servers connected to a network.

The portion of housing 752 containing computing device 770 has a central axis 766. Computing device 770 is connected to an imaging device 810, such as a CCD. An optical axis 809 extends from imaging device 810, through one or more optical elements (shown for clarity as a single lens 780, although it will be understood that lens 780 may be a lens group, or one or more lenses or other optical elements as desired. Lens 780 may be a fixed focus macro lens arrangement with a large depth of field. Alternatively, lens 780 may be an autofocus lens arrangement. Lens or lenses 780 focuses an image of an eye (not shown) onto imaging device 810.

A near-infrared LED 574 is connected to computing device 770 and is controlled selectively by computing device 770 in response to trigger input 776, or directly from trigger input 776 if desired. Item identification device 772 is mounted in the housing, and may be an RF ID sensor, a bar code reader, or other device for identifying items. Handle 754 may include a rechargeable battery 762 held in a removable handle portion 760. Removable handle portion 760 can be removed from receptacle 774 for recharging and may be removed and replaced with a spare handle portion 760 if it becomes discharged during use. Battery 72 is connected to contacts 764 so that the handle portion 760 can be inserted into a compatibly shaped charger (not shown) and recharged, either with the device 750 connected or separately from device 750.

Device 772 for identifying items may be used, for example, to identify medication packages or other items to be given to the patient in a manner described previously. Trigger 776 may be used to activate the iris camera components of the device, or the item identification device 772, depending on the operating mode of the device and its programmed sequence of operation. Also, the touch screen 756 and the buttons 758 can be used to activate and control the identification functions of the device.

In an embodiment, this device is used to implement the processes of FIGS. 3a and/or 3b. In the embodiment of FIG. 3a, the step 318 of comparing medications to the displayed order may include reading a bar code or RF ID tag on the medication container using device 772 and automatically verifying a match with the medication package issued by the pharmacy for that patient before administering the medication.

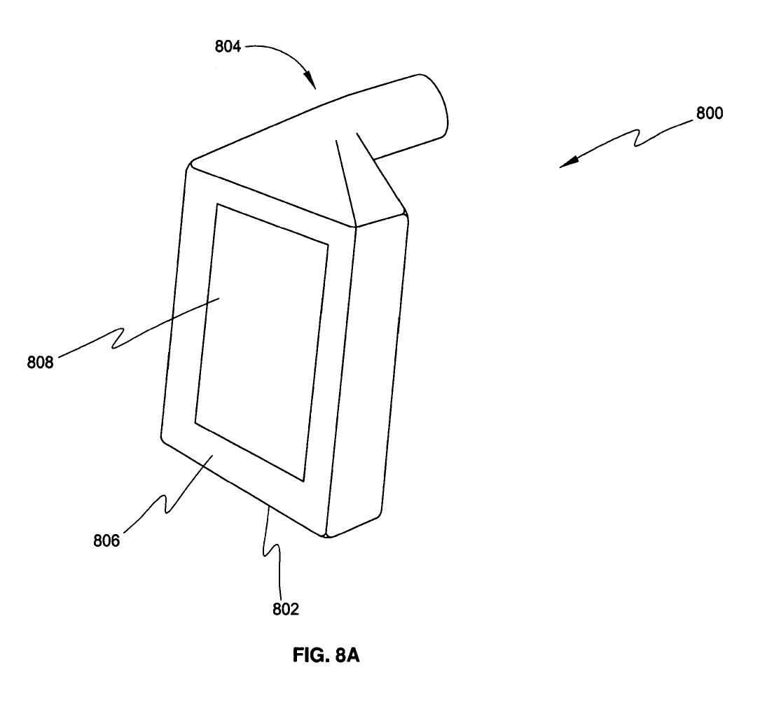

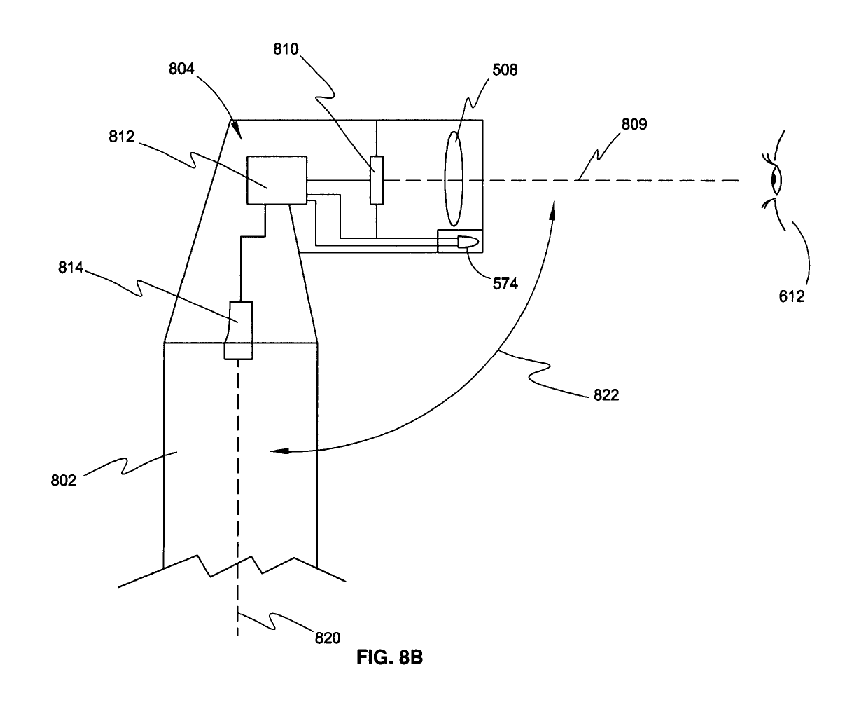

FIG. 8a is a perspective view of an exemplary embodiment of a portable iris identification camera configured as an attachment for a handheld computing device. As shown in FIG. 8a, device 800 is assembled by connecting a computing device 802 to a camera unit 804. Computing device 802 may be a commercially available handheld computer such as a PDA or an industrial grade portable computer. Computing device 802 has a housing 806 and, in a preferred embodiment, a touch screen 808 providing both a display mechanism and a user input mechanism for computing device 802. Camera unit 804 is configured to mount flush with housing 806 and connects to housing 806. The camera unit 804 and housing 806 may be held together using various types of fasteners such as screws or adhesives, using an adjustable strap (not shown) which may have hook and loop fasteners for mounting, using an electrical connector such as a PC card, USB connector, or other electrical connector or slot, using clips or connectors provided on computing device 802 to hold external attachments, or through any combination of these or other known means of holding two devices together.

In the exemplary embodiment illustrated in FIGS. 8a and 8b, camera unit 804 is mounted on one end of computing device 802. However, the invention is not limited to any particular mounting location, and camera unit 804 may be mounted on the back, sides, ends, or any other available location of computing device 802.

FIG. 8b is a cutaway view of the camera unit 804 of FIG. 8a. Camera unit 804 captures an image of an eye 612 along an optical path 809. Optical path 809 extends linearly from eye 612 through at least one lens 508 to imaging element 810. Imaging element 810 may be a CCD or another electronic imaging component that can generate digital images of the eye, preferably one responsive to near-infrared wavelengths. An illumination source 724, such as one or more near-infrared IR LEDs, is mounted offset from optical path 809 and aimed toward eye 612 to illuminate the iris.

In the specific embodiment illustrated in FIGS. 8a and 8b, the optical path 809 is arranged at approximately right angles to a central longitudinal axis 820 of computing device 802. However, the geometry of optical path 809 relative to computing device 802 may be arranged at any desired angle. As examples, similar to the embodiment of FIGS. 7a and 7b, optical path 809 may be adjustable, or may be aimed upward from the right angle position shown. The inventors have found that it may be desirable for ergonomic reasons to set optical path 809 at an angle 822 of approximate 135 degrees. In another embodiment, angle 822 between optical path 809 and axis 820 may be selected within the range from 120 degrees to 150 degrees.

Imaging element 810 is connected to interface circuit 812, which is connected to computing device 802 in this exemplary embodiment through a connector 814. Connector 814 may be, for example, a USB connector, PC card connector, SD card slot, serial port, or other data connector provided on computing device 802. Interface circuit 812 provides an interface to transmit digital image frame output from imaging element 810 to computing device 802. A portion of interface circuit 812 is also connected to illumination source 724, and this portion selectively activates illumination source 724 in response to a signal from computing device 802. For example, computing device 802 may transmit a signal on a USB channel to activate illumination source 724, and this signal will cause interface circuit 812 to connect operating voltage to illumination source 724.

Power for camera device 804 may be provided by batteries or an external power source, but is preferably obtained from computing device 802. For example, if connector 814 is a USB connector, power (typically up to 0.5 A) from the computing device 802 will be available at the connector 814. Power for the illumination source 724 is similarly obtained from computing device 802, and interface circuit 812 may include power conditioning and/or voltage conversion circuits if illumination source 724 has operating voltage or power characteristics different from those available directly from connector 814. Power to illumination source 724 is preferably controlled by a MOSFET or other transistor or IC device capable of carrying and switching the power drawn by illumination source 724. The device selected is connected to respond to signals from computing device 802 to selective actuate and deactuate illumination source 724 during image capture. If illumination source 724 comprises more than one element, such as two or more LEDs or other light sources, these elements may be separately controlled, and actuated in sequence or together, as needed depending on ambient conditions and depending on the requirements of image capture and live-eye validation algorithms used in the system.

A single element lens 508 is shown for simplicity, but those skilled in the art will appreciate that an optical lens assembly comprising a plurality of optical elements may be used to achieve particular focusing, depth of field, and image quality objectives. Optical assemblies appropriate for camera unit 804 can be designed and constructed in a conventional manner based on the objectives established for a particular embodiment.

In an exemplary embodiment, the optical elements of camera unit 804 are adapted to have a large depth of field with a center of focus approximately four inches from the camera unit 804. Thus, if the camera unit 804 is aimed at the eye, held at a distance of about four inches from eye 612, and moved back and forth along optical path 809, an in-focus image of eye 612 can be captured. In alternative embodiments, the optical elements of camera unit 804 may include one lens, a group of lenses, an adjustable focus lens system, or an adjustable-focus autofocusing lens system.

Device 800 may be used in any of the same operating modes and processes as the devices shown in FIGS. 6a and 6b and 7a and 7b and described herein with reference to those figures, and may optionally be provided with any of the features described herein with reference to the embodiments of FIGS. 6a, 6b, 7a, and 7b. Similarly, any of the features or options described herein with reference to device 800 and FIGS. 8a and 8b may be implemented in the embodiments shown in FIG. 6a, 6b, 7a, or 7b.

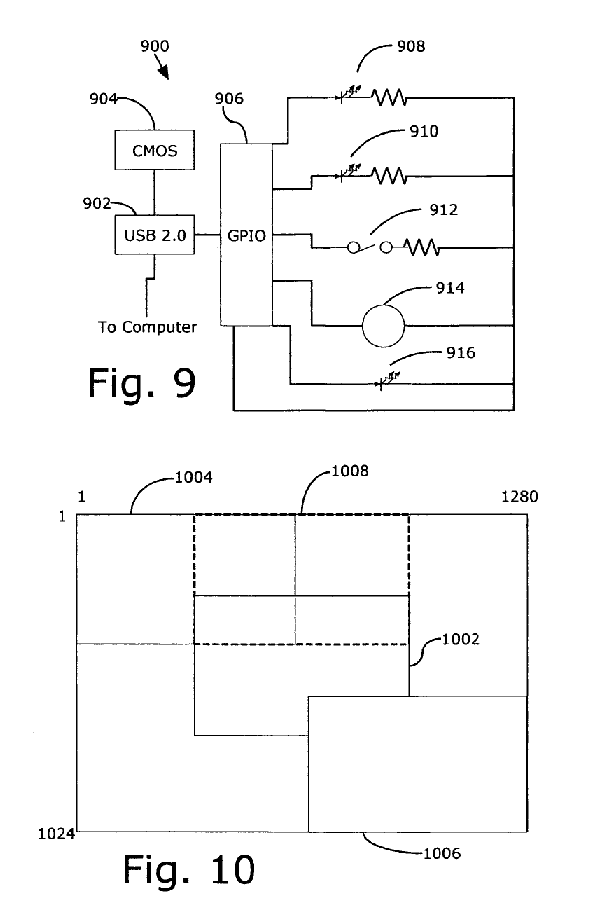

FIG. 9 is a block schematic diagram of a further iris camera embodiment. In this embodiment, a USB 2.0 interface 902 provides a connection between a computer (not shown) and the camera 900. Interface 902 provides connections for sensing and control of General Purpose Input/Outputs (GPIOs) 906. Illuminators 908 and 910 (which may be near infrared LED illuminators) can be powered directly from the GPIOs or through a simple transistor driving circuit as is well known in the art, depending on the power drawn by the LEDs and the current sourcing or sinking capacity of the GPIOs. A trigger switch 912 can be connected to the GPIOs 906 and its position can be sensed by software in the computer through the GPIOs 906. A CMOS camera 904 is also connected through USB interface 902 to the computer. In this embodiment, CMOS camera 904 is preferably a 1.3 megapixel to 3.0 megapixel camera.

Camera 900 is equipped with a lens (not shown) selected experimentally to provide a target iris size at a selected distance. For example, to produce an iris diameter of about 200 pixels at a distance from the iris (for example) between 4 and 6 inches, lenses with a focal length in the range of 6 mm to 12 mm may be appropriate depending on the pixel sensor size and resolution of the CMOS imager. The selected lens may be mounted on the imager using a C, CS, M-12.5, M8, M7, or other standard or customized mounting method. Appropriate lenses are available in stock or designed to specification, for example, from Genius Electronic Optical Co., Ltd., Daya Township, Taiwan; Universe Kogaku America of Oyster Bay, N.Y.; Sunex Optics of Carlsbad, Calif.; Marshall Electronics of El Segundo, Calif.; and other manufacturers.

While typical prior art iris cameras have used a 640×480 (VGA) imager, the inventors have discovered that using a higher resolution imager in embodiments of the invention may offer significant benefits. First, the higher resolution of the imager allows a design with a wider field of view while maintaining a minimum desired number of pixels in the diameter of the iris. Thus, a wider-angle lens than would be required with a VGA imager can be used, having a reduced focal length, thus providing a greater depth of field of the image. Second, the expanded field of view makes it possible to reduce the need for accuracy in aiming the camera. This can be accomplished in several ways.

In one embodiment, a larger frame is transmitted to the computer and the iris location within the frame is determined by computer analysis of the larger frame. The eye location can be determined using known algorithms. One effective and simple algorithm searches the image data for circular patterns, and uses the circular reflections in the pupil of the LED illuminators to identify the center of the eye. Then, the image data in the region containing the iris can be selectively provided to the iris identification algorithms for enrollment or matching, for example, in a 640×480 format.

In another embodiment, a series of smaller frames, such as 640×480, are selectively obtained from different parts of the overall camera field of view by controlling the camera to transmit a series of sequential overlapping “region of interest” frames. Preferably, the overlaps are selected to be at least 200-250 pixels so that an iris of the target image size (e.g. 200-250 pixels in diameter) must be entirely contained within at least one of the frames rather than always appearing across two frames. FIG. 10 is a diagram showing one example method of dividing a larger frame into region of interest frames. This embodiment divides a 1024×1280 frame into 9 VGA frames which are sequentially selected by commands to the camera and transmitted to the computer. The 9 frames are: the center frame, top left (1004), top right, middle left, middle right, bottom left, bottom right (1006), top center (1008), and bottom center. When these frames are received by the computer, they can be processed to determine whether they appear to contain an eye image, or can simple be submitted to the iris identification algorithm to see if a match or enrollment is possible.

The sequence of region selections is preferably programmed to increase the likelihood of rapid location of the correct frame. For example, central frames such as frame 1002 may be transmitted before more peripheral frames such as frame 1004 and frame 1006. Further, the frames centered around the central vertical and/or horizontal axis of the full scale image may be obtained before the leftmost and rightmost frames or the topmost and bottommost frames are obtained, respectively.

In a further embodiment, a series of frames larger than VGA resolution are obtained. Depending on the resolution of the camera, frame transmission speed, desired frame rate, and desired angle of view, those skilled in the art can select a frame size such as 1200×1600, 1024×1280, 820×960, 600×800 or other desired dimension. Then, these frames are divided into a series of overlapping images in the correct size for the iris algorithms (e.g. 640×480) and submitted to the iris algorithms for processing without attempting to determine whether they contain a valid iris image. The iris identification algorithms will fail to process images that do not contain a valid iris image, but will identify the person or accept an enrollment if a valid iris image is submitted.

Cameras that can be used in various embodiments of the invention include model no. GLN-B013 (monochrome) and CLG-C030 (color) from Mightex Corporation of Pleasanton, Calif. (these cameras also include high power LED driving circuits that can be used instead of GPIOs to control the LED illuminators). Other potentially suitable cameras include web cam imaging modules such as the module used in the Logitech Notebook Pro 2.0 MP autofocus camera, and Faymax FC1000 or FC1001 modules from Faymax of Ottawa, Ontario Canada. In one preferred embodiment, a web cam imaging board incorporating a Micron Model 2020 2.0 megapixel CMOS sensor (without IR cut filter) and an autofocus module with an M7 lens mount can be used. Preferably, the camera default settings are adjusted to maximize image quality under near infrared illumination.

IR cut filters typically should not be used in this application since illumination for iris identification is often chosen in the near-infrared range to increase visibility of iris patterns. A high pass filter that removes most visible light elements, allowing the wavelengths of the selected near infrared imagers to pass, is preferably installed in the imaging path. Appropriate illumination wavelengths may include one or more wavelengths between 700 and 900 nm. As one example, an 830 nm illuminator can be used. Illumination wavelengths are selected experimentally, based on the response of the selected imager, to maximize visibility of iris patterns.

In an embodiment, the division of a full image into subregions for processing in the various approaches described above is used only for identification, while enrollment uses only eye images from the center of the field of view to ensure uniform illumination.

If GPIOs 906 are not included in the camera module, they can be implemented by connecting CMOS camera 904 to the computer through a USB 2.0 high speed hub, and connecting a USB GPIO module to the hub. For example, the Alerter-E4, EUSB 3 I/O, or EUSB 6 I/O kits from Erlich Industrial Development Corp. of Charlotte, N.C. provide workable platforms for control and sensing of LED circuits and other devices. Circuits designed around a Cypress CY8C-24894 microcontroller can also be used for this purpose, as this microcontroller incorporates a USB interface.

A piezo buzzer or speaker 914 may be provided to give audible signals to the operator from the camera. Also, one or more LEDs 916 may be provided for signaling and aiming purposes. In an embodiment, an LED 916 is provided to indicate a correct distance range from the target eye, and piezo buzzer or speaker 914 is selectively used to provide an audible indicator of correct distance. The audible indicator may beep periodically when the eye is in view, and beep at a faster rate when the eye is in range. The “in range” determination can be made by calculating the iris diameter in pixels, or by using a focus determination algorithm on the image. The center of the focal range of the lens is preferably designed to coincide with the point where the iris image has optimal dimensions, so that either method or a combination of the two methods will indicate correct range.

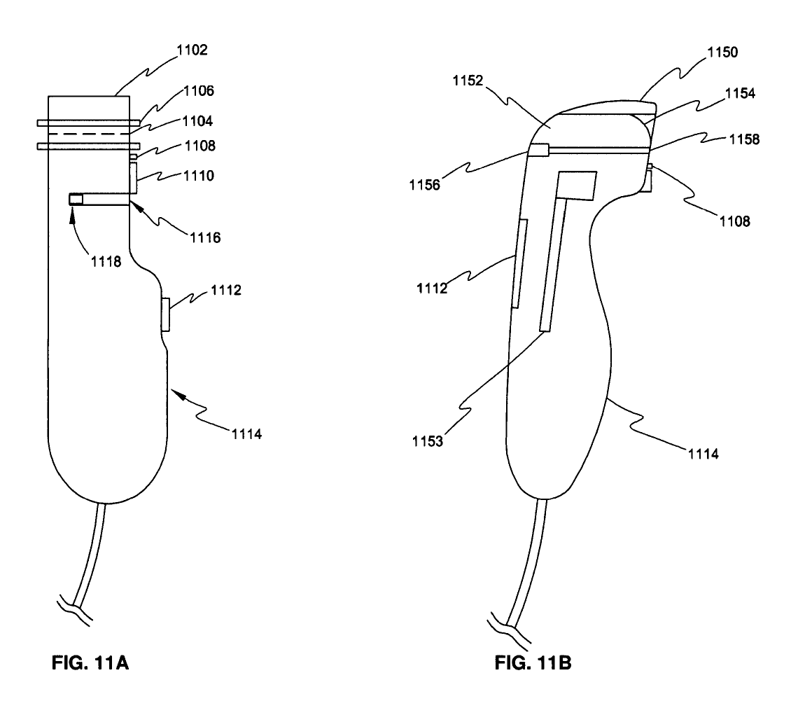

FIGS. 11a and 11b show alternative camera housing structures that can be used with the embodiments described herein. Housing 1102 has a hand-shaped grip area 1114 including a trigger switch 1112. At the top of housing 1102, there is a viewfinder 1104 which is a flat black hollow tube with a diameter typically in the range of ¼ to ½ inch, e.g. ⅜″. Each end of tube 1104 has around its circumference a lightguide (round, square, or other shaped cross-section) connected to an LED indicator. For example, the lightguide may be illuminated with a green or blue color to indicate “in range” conditions. In operation, the operator sights through the tube 1104 and moves the camera closer until the LED lightguide glows, then holds the camera in position for enrollment or identification. For self-identification, the person to be identified can look through the other end of tube 1104 in a similar manner. Camera 1110 and LED illuminator 1108 are positioned to illuminate the target eye and capture its image. As another option, an LED 1118 can be illuminated at the back of a small diameter tube 1116, and for self-identification the subject can move the camera until he/she is able to see the LED 1118, ensuring proper aiming.

FIG. 11B shows another viewfinder design in which housing 1150 is provided with a tunnel 1152, an angled reflective lens 1154 of a type used in “red dot sights” on firearms, an LED illuminator 1156, and a tunnel 1158. Camera module 1153 is aimed at the same target point as tunnel 1158, illuminator 1108, and viewfinder 1152. The LED 1156 can be seen through the tunnel 1158 to support self-aiming, and has a small hole output directed toward lens 1154. The operator sees a dot in the center of the lens 1154 and can align that dot with the center of the target eye for aiming. The focal point of the apparent image of the dot is adjusted, by moving LED 1156 closer to lens 1154 so that the focal point corresponds to the designed eye distance, such as 4-6 inches from the front of the housing.

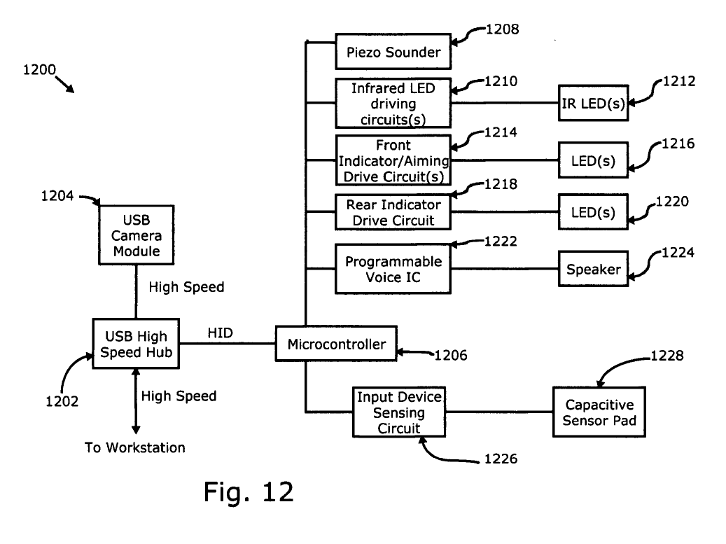

FIG. 12 is a block schematic diagram of one preferred embodiment of a circuit for a portable iris identification camera. Camera circuit 1200 preferably includes USB camera module 1204, USB high speed hub 1202, microcontroller 1206, infrared driving circuits 1210, one or more IR LEDs 1212, front indicator/aiming drive circuits 1214, one or more LEDs 1220, and an input device sensing circuit 1226. Circuit 1200 preferably includes one or more audible devices, such as piezoelectric sounder 1208 and programmable voice integrated circuit 1222, the output of which may be connected to speaker 1224. Input device sensing circuit 1226 is connected to a switch or other user-operated input device such as capacitive sensor pad 1228. The device connected to input device sensing circuit 1226 is a means for the user to provide a control input to the device, for example, to indicate that the user is ready to start identification of a person, or that the user wishes to scan a barcode.

IR LED(s) 1212 are used to illuminate the target iris or other target item such as a barcode so that camera module 1204 can image the target. In a preferred embodiment, two or more IR LEDs 1212 are used. IR LEDs 1212 are selected by experimentation to produce optimal imaging with the camera module 1204 and filters installed for use with the module 1204. Typically, IR LED wavelengths may be selected in the range from 700 to 900 nm. In a preferred embodiment, an 830 nm wavelength may be used, or a combination of wavelengths such as 780 nm and 830 nm, or 830 and 880 nm may be used. IR LEDs may be obtained from various sources, such as Marubeni America of Sunnyvale, Calif. LEDs 1216 are used as status indicators on the front of the camera, and are used for illuminating the target area to assist the user in aiming the camera when the camera is used for a function other than iris imaging, such as barcode reading. Separate LEDs may be provided for these two purposes. In a preferred embodiment, one or more very bright green LEDs 1216 are provided and used for both purposes. As an example, Kingbright model WP7104VGC/Z green LEDs have a typical 9000 mcd brightness capacity. These LEDs may be driven at their full rated current when used to indicate the target image area for barcode reading, and may be driven at reduced brightness (for example, by switching an additional resistor into series with LEDs 1216) when used as visual indicators to indicate that the camera is in-range or that identification has been accomplished during iris imaging. Because LEDs 1216 face the imaging target, very bright LEDs will create discomfort for a human subject during iris imaging. Thus when the LEDs 1216 are used as status indicators for iris imaging, rather than as area illuminators, they are preferably operated at significantly reduced brightness. To facilitate use as target area illuminators, LEDs 1216 may be provided with a lens that shapes the projected light on the target, such as a cylindrical lens that produces a line or bar of light on the target. It is desirable for any aiming device or other illumination provided in barcode mode to be safe for human eyes in case the camera is accidentally pointed at a person while in barcode mode.

While it is possible to provide separate illumination sources and imaging devices for iris and barcode imaging functions, in a preferred embodiment the same USB camera module 1204 is used for imaging both irises and barcodes. In this embodiment, the IR LEDs 1212 are used as illuminators for both iris and barcode imaging. In this embodiment, the designed focal distance between the camera module 1204 and the target iris or barcode is selected so that a single distance is appropriate for both purposes. A distance of about five to six inches between the camera and the image target is considered a reasonable compromise to enable both barcode and iris imaging with the same device.

The firmware of microcontroller 1206 preferably implements a command set of short commands (for example, one byte commands) that can be transmitted to microcontroller 1206 by the software in the workstation via the USB HID interface to cause desired actions. As examples, commands may be provided to manually control each item connected to microcontroller 1206, and to initiate predetermined combinations of lights and sounds that are frequently desired to provide indications to the user during iris and barcode imaging. Microcontroller 1206 also preferably communicates with the workstation by sending short data signals, such as one byte signals. For example, microcontroller 1206 may send a one-byte signal to the workstation when the input device sensing circuit indicates that the user is providing input, such as pressing a button to initiate an action.

The command set of microcontroller 1206 preferably includes a mode command for switching the camera between iris imaging mode and one or more additional modes, such as barcode reading mode. The functions of camera circuit 1200 and the response to commands from the workstation will be adjusted appropriately depending on the selected operating mode. For example, in iris imaging mode, LEDs 1216 may be operated only at low intensity to prevent discomfort for the human imaging subject. As another example, if the camera's input device is not used in iris imaging mode, monitoring of the input device sensing circuit may be suspended in iris imaging mode, and be active only in selected other modes such as barcode mode. Operation of each device controlled by microcontroller 1206 may be different, as appropriate, in the different selected operating modes.

In this embodiment, USB high speed hub 1202 is connected by a high-speed connection to a workstation, which may be a portable or fixed computing device. This high speed connection may be a wired or wireless connection. In the case of a wireless connection, the connection may use a wireless protocol other than USB that provides bandwidth similar to a high-speed USB 2.0 connection, operating via an intermediate wireless circuit (not shown). Hub 1202 is connected via high-speed USB 2.0 lines to camera module 1204. Camera module 1204 is preferably a modified high-resolution webcam-type device. For example, camera module 1204 may use a Micron 2.0 megapixel sensor, model 2020 ordered without an IR cut filter, or another module determined by testing to provide acceptable performance in this application. Camera module 1204 preferably includes an autofocus module and a lens selected in combination with the autofocus mounting and the sensor so that it produces an image of a human iris of approximately 200-250 pixels in diameter, when positioned at a selected designed operating distance from the target eye. The design distance may be any desired distance. The inventors prefer a designed operating distance of 4-7 inches, most preferably 5 or 6 inches. The lens may typically be selected with a focal length of 5-9 mm, although this selection depends on the other components and may in some cases be outside this typical range.

Microcontroller 1206 is connected to hub 1202 via a USB connection. In the preferred embodiment, this connection is used only to convey short control signals between the workstation and the microcontroller 1206, and may therefore be a low speed connection, such as a Human Interface Device connection. This connection uses minimal USB bandwidth and therefore will not interfere with the transmission of a high volume of image data to the workstation via the same USB wires. It is normally desirable to obtain the highest possible data rate for image data transmission, so other data transmission requirements are typically minimized by design so the capacity of the USB connection can be devoted almost exclusively to image data transmission.

Microcontroller 1206, which may be a Cypress model CY8C-24894, is connected to control piezo sounder 1208, infrared LED driving circuits 1210, front indicator/aiming drive circuits 1214, rear indicator drive circuit 1218, and programmable voice IC 1222, and is connected to receive signals from input device sensing circuit 1226. Microcontroller 1206 is provided with firmware that controls the functions of the connected devices according to the disclosure herein. The Cypress CY8C-24894 incorporates circuits and firmware for capacitive sensing, so that a capacitive sensor pad 1228 can be implemented as the user input device with the additional of minimal external components in input device sensing circuit 1226. Microcontroller 1206 may be programmed to generate tone outputs as indicator signals to indicate aiming and positioning information and completion of tasks. These outputs may be provided through the connected piezo sounder 1208. Also, a programmable voice IC 1222 may be provided to generate verbal instructions and reports to the user through speaker 1224. As an example, programmable voice IC 1222 may be an aP89085 one-time-programmable voice IC manufactured by APlus Integrated Circuits, Inc. of Taipei, Taiwan. This device can be controlled to produce pre-programmed voice instructions in response to I/O line control signals from microcontroller 1206. For example, messages such as “Please move a little closer,” “Please move back a little,” “Thank you, identification complete” and similar status and instructional messages can be generated by camera 1200 to assist the user. The capacity of voice IC 1222 is preferably selected to allow the set of messages to be recorded in multiple languages, and a desired language can be set at each workstation for its connected camera by sending a language selection instruction to microcontroller 1206, which will then select a message in the requested languages whenever it activates voice IC 1222. Volume control and muting functions are also provided for user configuration of the operation.

LED driving circuits 1210, 1214, and 1218 will typically include current limiting resistors in series with the LEDs, so that the LEDs do not burn out due to operation above their rated current and voltage capacity. These resistors are selected with reference to the data sheet for the LEDs used so that the specified current and voltage drop across the LED is not exceeded.

Also, the I/O ports of microcontroller 1206 have limited drive capacity. Therefore, if the infrared LEDs 1212, LEDs 1216, and/or LEDs 1220 draw more current than the microcontroller ports can provide directly, driving circuits 1210, 1214, and/or 1218 may also include transistor switches that can be controlled by a low-current signal from microcontroller 1206 to switch the higher current required to activate the LEDs. For example, model MMTD3904 transistors manufactured by Micro Commercial Components of Chatsworth, Calif. can be used to switch power to the LEDs.

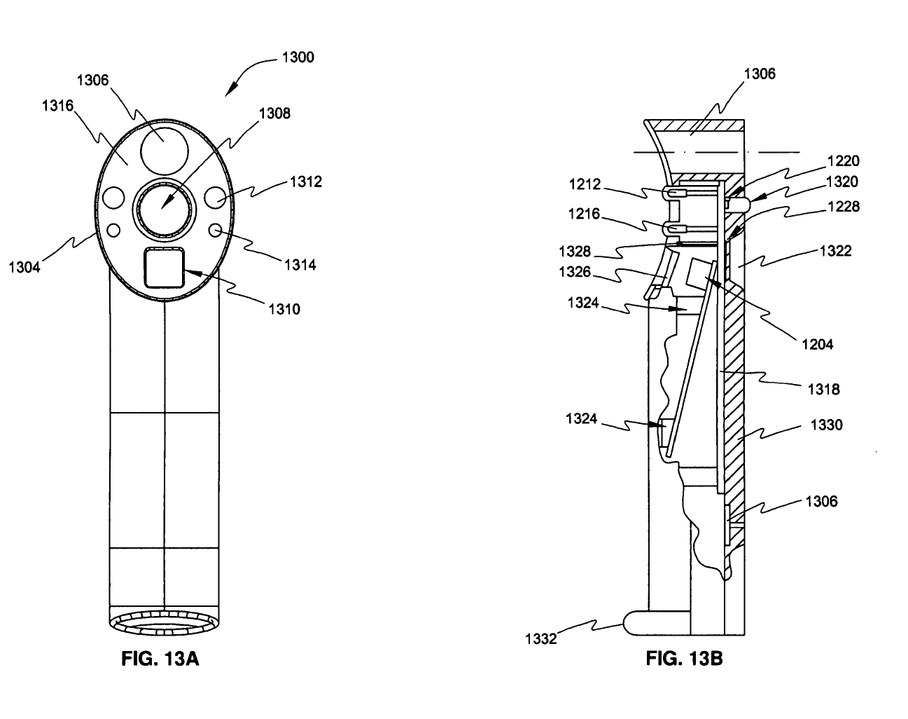

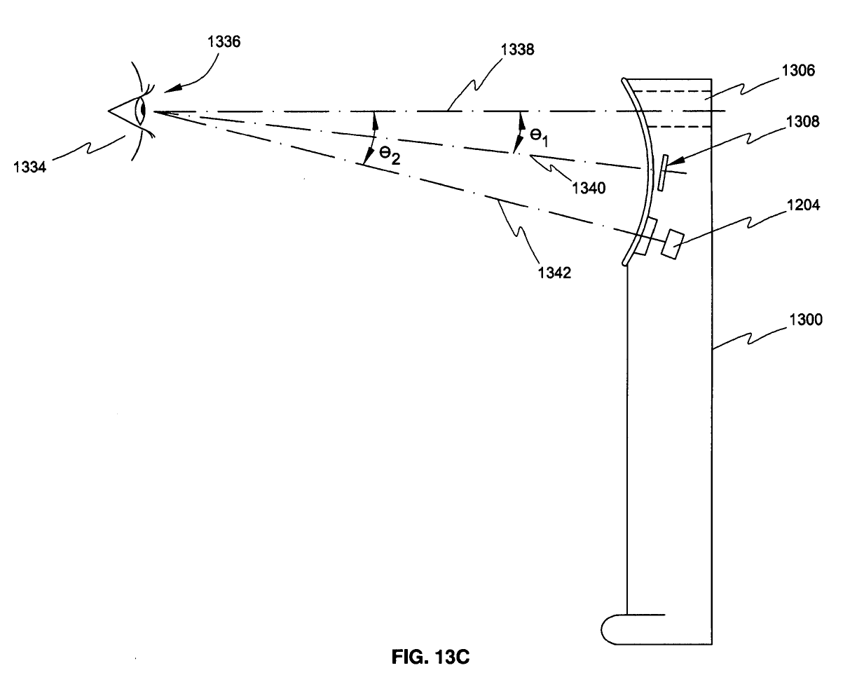

FIG. 13a is a front view of a preferred embodiment of a handheld iris imaging camera 1300. Housing 1300 preferably contains the camera circuit 1200 shown in FIG. 12. Housing 1300 includes a head 1304 and a handle. In the face 1316 of head 1304, there is a viewfinder 1306. Viewfinder 1306 may incorporate any combination of the viewfinding features described previously with respect to other embodiments. In the embodiment shown, viewfinder 1306 is merely a plain circular tube. Viewfinder 1306 may be capped at each end by a clear plastic or glass element, or may be left open. The USB camera module 1204 described with reference to FIG. 12 is mounted to view imaging targets through camera aperture 1310. Diffusers 1312 are provided for IR LEDs 1212. Lenses 1314 are provided for LEDs 1216. A mirror 1308 is provided so that the camera 1300 can be easily used for self-identification. The user merely looks at camera 1300 so that he can see his eye in mirror 1308, and the eye will be in proper position for imaging through aperture 1310.

FIG. 13b shows a side view of camera 1300 with a partial section to show an arrangement of components therein. In the embodiment shown, USB camera module 1204 is mounted at an angle on mounting points 1324. A high-pass optical filter 1326 reduces ambient light and passes the near infrared light produced by IR LEDs 1212. Filter 1326 is selected by reference to specifications for such filters, with a cutoff wavelength appropriate to the desired illumination effect with LEDs 1212 and camera module 1204. For example, if LEDs 1212 have an 830 nm nominal output, Filter 1326 may have a cutoff frequency of 780 nm, so that wavelengths below 780 nm are largely blocked, while longer wavelengths are passed through. The filter 1326 may be a glass or plastic element or a cold mirror, although a mirrored surface is considered unnecessary since there is a mirror 1308 for aiming. The arrangement shown is less expensive to produce than an arrangement using a mirror in the optical path of the camera, because mirror 1308 can be a low-grade cosmetic mirror rather than an element having the quality needed for optical iris imaging.

The camera housing in this embodiment also contains a circuit board 1318, which may contain the circuits shown in FIG. 12 other than the USB camera module 1204. Board 1318 is mounted at the back of the camera 1300 and protected by a cover 1330. LEDs 1212, 1216, and 1220 are mounted on board 1318. A wall 1328 extending between the housing and board 1318 separates the upper portion of board 1318, containing the LEDs, from the mounting location of camera module 1204. In this way, the LEDs are kept in a separate compartment above wall 1328, where light from the LEDs generated inside the camera housing will not be allowed to reflect into the area of camera module 1204. Board 1318 is connected to camera module 1204 by a short cable, flexible connector, or hardware connector (not shown) carrying USB signals between the camera module 1204 and the board 1318. The hub on Board 1318 is connected to a computing device or workstation by a USB cable extending through the bottom of the camera 1300. Of course, it is possible to place the USB hub 1202 on the board of camera module 1204 instead of on board 1318, in which case board 1318 will be connected to the hub and the USB connection to the workstation will extend from the board of camera module 1204.

Rear indicator LED 1220 is a green indicator LED. In the embodiment shown, LED 1220 is a reverse-mount LED, surface-mounted on the front surface of board 1318 with its light output facing through a hole in board 1318, then through lens 1320 which is visible from outside the housing. Capacitive sensor pad 1228 is provided as a circular copper pad on the back side of board 1318, connected to be sensed by the circuits on board 1318. A depression 1322 in the rear cover 1330 creates an area where the material of the cover 1330 is thin and a thumb or finger may be placed in this depression 1322 near capacitive sensor pad 1228. The user may thus indicate a desired function, such as scanning a bar code, by moving his thumb into depression 1322. A mechanical switch could also be used, but in the embodiment shown, a control input is implemented with no moving parts and with no apertures in the housing that must be sealed, as would be the case if a mechanical switch were used. Also, the capacitive sensor is actuated by presence of the thumb or finger, with no pressure required. Thus, if there is a need for the user to keep the control input actuated for a long period, this can be done with much less physical effort and fatigue. Finally, piezo sounder 1208 is connected by wires to board 1318 and mounted on cover 1330 with an aperture to the outside of the housing. Preferably piezo sounder 1208 is of made of durable and environmentally resistant material such as stainless steel.

In the embodiment shown, the operating components of camera 1300 are substantially sealed within the housing and no entry points are provided that would allow moisture, sand, etc. to interfere with the working components.

FIG. 13c is a side view of the preferred camera embodiment of FIGS. 12 and 13a. For more user-friendly operation of the camera, the inventors have determined that it is desirable to optimize the geometry of several elements. As shown in FIG. 13c, an eye 1334 has a target point 1336 at the center of the outer surface of the pupil. This target point is the nominal desired aiming point for imaging the iris. As shown, the viewfinder 1306 has a central axis 1338 that intersects with aiming point 1336 at a distance of about six inches from the front of the camera. In typical operation, when imaging the iris of another person, the operator will hold the camera so that he can see the target iris through viewfinder 1306, and slowly move the camera toward the target until the visual and/or audible indicators on the camera indicate that the camera is in the correct range.

The mirror 1308 is set at an angle θ₁ from vertical so that its central viewing axis 1340 intersects axis 1338 at the target point 1336. Similarly, camera 1204 is set at an angle θ₂ to vertical so that its optical viewing axis 1342 is at angle θ₂ to axis 1338 of the viewfinder. Thus, the camera's optical axis 1342 intersects aiming point 1336 when the camera is at the designed focal distance from the target. The mounting angles to achieve the desired intersection depend on the dimensions of the camera and can be determined by geometry. In an example embodiment constructed by the inventors, θ₂ is approximately 12 degrees and θ₁ is approximately six degrees.

The mirror 1308 allows the user to self-identify in the following manner. The user holds the camera so that he can see one of his eyes in mirror 1308. He then moves the camera slowly toward his eye until the audible and/or visual indicators on the camera indicate that the correct range has been reached.

The inventors have found that a slight upward angle of the camera as shown, while not essential to basic functionality, often produces better results. Gravity and human anatomy tend to combine to cause the upper eyelid and eyelashes to obscure part of the iris when the subject looks forward or up. When the subject eye is slightly above the camera, and the camera is thus looking “up” at the eye, the eye is less likely to be shaded or obscured by the upper eyelid and eyelashes. As a result the inventors have observed faster capture of a valid image for enrollment and identification with this configuration of the handheld camera. Angling of the mirror is also not essential to operation. However, with the mirror angled in this manner, when the camera is in the correct range, the operator can see the target eye through the viewfinder and the subject can see his eye in the mirror. Thus, there is no incentive for the subject to try to move his head to see his eye in the mirror, which can interfere with fast image capture. With this geometric arrangement of elements, the subject's eye will be in a good position for imaging regardless of whether the subject is looking at the viewfinder or the mirror.

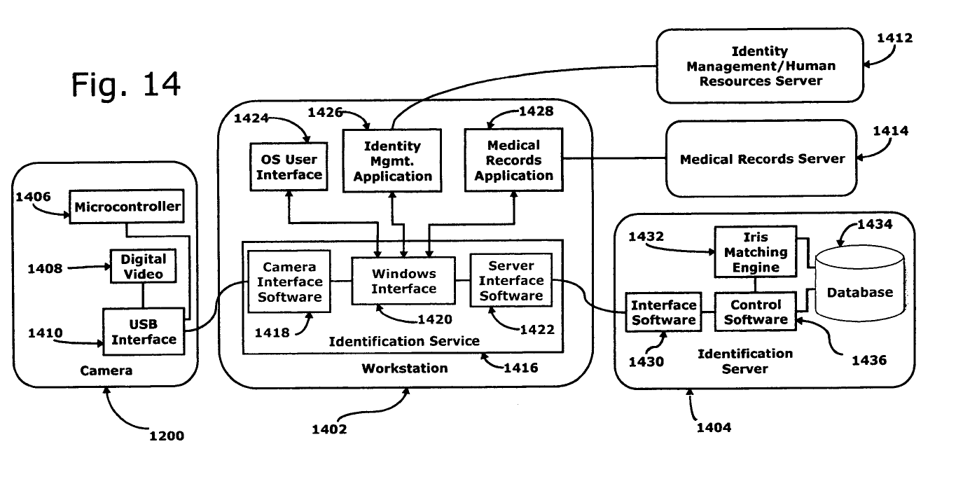

FIG. 14 is a block schematic diagram of an exemplary software arrangement for one preferred embodiment of an iris identification system. As shown in FIG. 14, camera circuit 1200 may incorporate a USB interface 1410, digital video 1408, and microcontroller 1406. Microcontroller 1406 preferably has firmware that implements a simple command set so that the control functions of microcontroller 1406 can be actuated by external software commands received through USB interface 1410. Digital video 1408 similarly has firmware that responds to commands received through interface 1410 to control functions of the camera, such as operating modes, brightness, contrast, gain and focus adjustments, image size and other image parameters.

A workstation 1402 is a computing device that operates to control the camera and receive data from the camera, and provide that data to other functional elements through an interface. Workstation 1402 may be, for example, a computer using a Microsoft® Windows operating system. Workstation 1402 may, however be any computing device and may use any desired operating system. Further, workstation 1402 may have any desired form factor—it may be a handheld device, tablet PC, notebook PC, desktop PC, or have any other known configuration. For example, workstation 1402 may have any of the configurations and features described herein with reference to FIG. 4.

In the example shown, workstation 1402 is a Windows PC running an identification service 1416 as a Windows service. The software implementing the identification service 1416 includes camera interface software 1418, a Windows interface 1420, and a server software interface 1422. Workstation 1402 may operate any desired combination of other software. In the example shown, workstation 1402 is running an OS user interface 1424, an identity management application 1426, and a medical records application 1428. Identity management application 1426 communicates with an identity management, human resources, or security service 1412. Medical records application 1428 communicates with a medical records server 1414.

The server interface software 1422 in identification service 1416 communicates with an identification server 1404, which may be located in the workstation but is typically connected to the workstation via a network such as a local area network, the internet, or another data network. Identification server 1404 includes interface software 1430 that communicates with server interface software 1422. Control software 1436 controls operation of the server to perform the desired server functions. An iris matching engine 1432 implements an accurate iris identification algorithm by matching iris pattern data extracted from live images to iris pattern data stored in a database 1434. The matching engine indicates to control software 1436 if a match is found or not found. If a match is found, the control software 1436 retrieves an identifier from the record in database 1434 corresponding to the identified person.

Each record preferably stores at least the iris pattern data of the person and one or more identifiers corresponding to the person. These identifiers may be a number, character sequence, or other unique data element assigned by an organization to the person. A person may have identifiers in more than one category and from more than one organization using the same server. For example, a staff member at a hospital may have a staff identification number, and may also be assigned a patient identification number by his employer for use when receiving medical care at the facility. When a match is found, if more than one set of identifiers is in the database, the server determines which identifier to return to the requesting workstation, based on characteristics of the request from the identification service 1402. The request from identification service 1402 may explicitly indicate the desired type of identifier to be returned (e.g. staff or patient) or the appropriate type of identifier may be deduced from the type of application that requested the identification. For example, requests from the identity management application may be presumed to relate to staff log-in operations, and requests from medical records applications may be assumed to relate to patient identification. The category of identifier to be returned may also be determined based at least in part on location information that is received with the request. For example, a central identification server 1404 may store patient records for more than one facility. If the records have patient identifiers for two different hospitals, the identification server 1404 may select the identifier based on the location of the requesting workstation in either the first or second hospital, returning the patient number that corresponds to the record system at the hospital where the patient is currently located.

Server 1404 provides a set of functions to workstations and to supervisory control stations attached to the server 1404. For example, these functions may include enrollment (adding new pattern data records to database 1434), recognition (using the iris matching engine to determine whether a person looking at the camera can be identified), and record maintenance such as deleting or correcting records. In addition, the control software maintains a secure log of all transactions performed by the server. The log may desirably include the location of the workstation, the identity of the logged-in operator, the ID number of the person identified, the application on the workstation that requested the identification, and the date and time.

Identification service 1416 can be activated by any authorized Windows application communicating with Windows interface 1420. Preferably, the identification service 1402 has an application programming interface provided a set of defined functions that can be called by other applications in the workstation. The most basic function is requesting an identification. In addition, if the workstation is authorized to perform enrollments, the function of adding a person's record for future identification can be provided. Additional functions such as deleting records, editing records, etc. may also be provided if appropriate to the expected use of the workstation.

In a preferred embodiment, the application calls the identification service 1416 to request an identification. The service 1416 activates the camera 1200 through the camera interface software 1418 to obtain iris images. As the images are obtained, the identification service 1420 processes the images. The software adjusts camera operation and controls signals to the operator to help the operator position the camera correctly to obtain quality images. Typically, when an image of reasonable quality is obtained it will be further processed to extract pattern data and obtained a reduced size template that can be transmitted to the server 1404 for matching. This pattern data extraction can also be done in the camera or the server. Extraction of pattern data in the camera reduces the bandwidth demands on the USB interface, but requires adding considerable processing power to the camera, increasing its cost. Extracting pattern data in the server significantly increases the network bandwidth needed to connect server 1404 to workstation 1402, since this option requires transmitting image data from the workstation to the server. Therefore, the inventors have found that pattern data extraction in the workstation is desirable when the goal is to support identity management and medical records applications as illustrated in FIG. 14. Using this method, pattern data for likely images may be continuously transmitted to the server for matching until a match is obtained or it becomes apparent that no match is present. If the server finds a match, it will return a context-appropriate identifier associated with the person's record. The identification service 1416 then returns the person's identifier to the calling program. The calling program can use this highly reliable identifier to authorize access to data, applications, or physical facilities, or to locate and display a record associated with the person, such as an employment record, credit record, medical record, customer record, benefits record, or other record.

The applications operating in the workstation may also, if authorized, request enrollment of a person. This is accomplished by calling identification service 1416 with an identifier that is to be associated with the record in identification server 1404. For example, for medical patient enrollment, the medical records application might call the enrollment function of identification service 1416, passing it a patient number assigned to the person. The identification service 1416 then activates the camera and collects and processes images as described previously. Once pattern data that is of sufficient quality to support an enrollment has been obtained, it is sent to server 1404 along with the person's identifier. The iris matching engine 1432 determines whether the new pattern data matches any existing records in the intended category of identifiers (in this case, patient ID). If so, the identification server issues an error report to workstation 1402 and provides the identifier of the existing record, so that the operator can review the person's existing record. In this way, creation of duplicate records is prevented. If there is an existing matching record, but no identifier stored in the patient ID category, the system adds the identifier to the appropriate field in the existing iris pattern record. If there is no existing matching record, the control software 1436 stores the pattern data and the associated identifier in a new record in database 1434.

For security purposes, the applications authorized to use the service can be selected using a configuration utility at the workstation, and the interface 1420 will reject service requests from applications that have not been so authorized. Any application that uses identification of a user, subject, record holder, etc. in its operation can benefit from an interface with the identification service. Several examples of applications are provided in FIG. 14. For example, an identity management application, such as a single sign-on application, a password management system, or a human resources record system can use the identification service 1416 to locate the record corresponding to an employee or other person looking into the camera. This identification can be used to authorize actions or to control access to electronic systems, records, and for physical access control.

In a preferred embodiment, identification service 1416 also provides access to barcode reading functions. In operation, applications operating in the workstation may call identification service 1416 to request a barcode reading function.

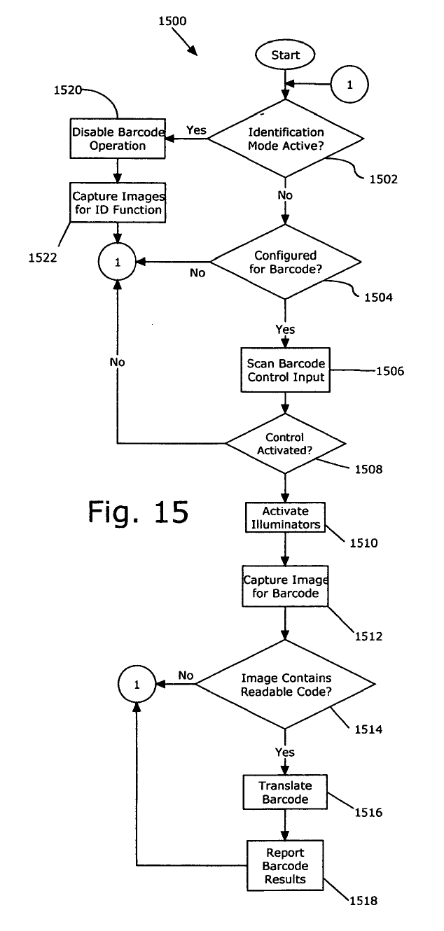

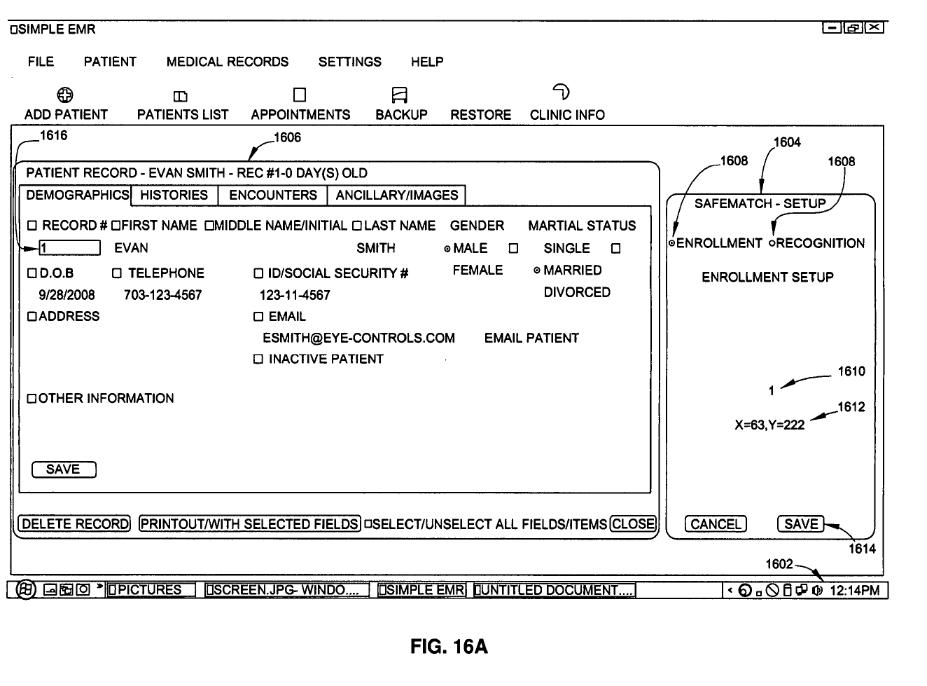

FIG. 15 is a flow chart showing an exemplary process for the operation of a multifunctional camera, such as any of the cameras described herein, to perform both iris identification and barcode reading functions. In this example embodiment, the functions shown are performed under the control of identification service 1416 shown in FIG. 14. Operation of the method shown in FIG. 15 begins with step 1502, where the controlling software determines whether the identification mode of the system is active. If so, barcode operation (which in this example is given a lower priority than identification operations) is disabled in step 1520. A “service not available” response is provided to any calling application requesting barcode operations and the barcode reading trigger on the camera is disabled. The identification service continues to capture images for the ID function in step 1522 in the manner described previously. If no identification operation has been requested, the system determines whether it has been configured to enable barcoding. If not, operation returns to step 1502 and the system will idle in the step 1502-1504 loop until an identification is requested, or the service is reconfigured to permit barcode operations.

If barcoding is enabled, operation continues at step 1506. In this step, the barcode control input on the camera is checked. Next, in step 1508, the service determines whether a barcode operation has been requested. If the user activated the camera's barcode trigger device (such as capacitive sensor pad 1228 shown in FIG. 12 or another trigger device), and the service is configured to accept trigger-initiated barcoding requests, operation continues at step 1510. Also, if the service is configured to accept barcode reading requests from software applications via Windows interface 1420 (shown in FIG. 14), such service calls will be treated as barcoding requests and operation will continue at step 1510. If no trigger actuation or other barcoding request is pending, operation returns to step 1502.

In step 1510, the camera's infrared illuminators are activated by camera interface software 1418 (shown in FIG. 14) and in step 1512, images are captured for barcode reading. Images may be captured continuously, or the service may wait for trigger actuation before analyzing the received images. Based on image focus analysis, if the camera is out of the range of its autofocus system, i.e. too far away to focus on the barcode, the camera's audible and visual indicators will indicate to the operator that he should move the camera closer. When a focused image is obtained, operation continues at step 1514. In step 1514 the image is processed by a barcode image analysis engine, for example, using software that is commercially available from Honeywell/HandHeld, Symbol Technologies, and various other companies known for developing barcode reading technology. If the barcoding engine determines that there is a readable barcode, operation continues at step 1516 where the engine translates the barcode to the data it contains, and then to step 1518. In step 1518 the barcode reading results are reported to the calling application, or may be stuffed into the keyboard buffer in the case of a trigger-actuated read operation. If no readable barcode is present, a failure report is transmitted to the calling application (if any) and operation returns to step 1502.

In this embodiment, a single camera selectively performs multiple functions, particularly including barcode reading and iris identification. The controlling software within the identification service selectively switches between a first operating mode where iris identification is performed and a second operating mode where barcode reading is performed. In the first operating mode, the camera is operated with a first set of parameters and user indications appropriate to iris identification operations. In the second operating mode, the camera is operating with a second set of parameters and user indications appropriate to barcode reading. Further, the processing of the images collected by the camera is different depending on whether the camera is operating in the first mode or the second mode. In iris mode, the images are typically pre-processed to extract pattern data and the data is communicated to a server for matching. In the barcode mode, the images are processed by a barcode reading engine. The control software provided as part of the identification service seamlessly switches between these two operating modes.

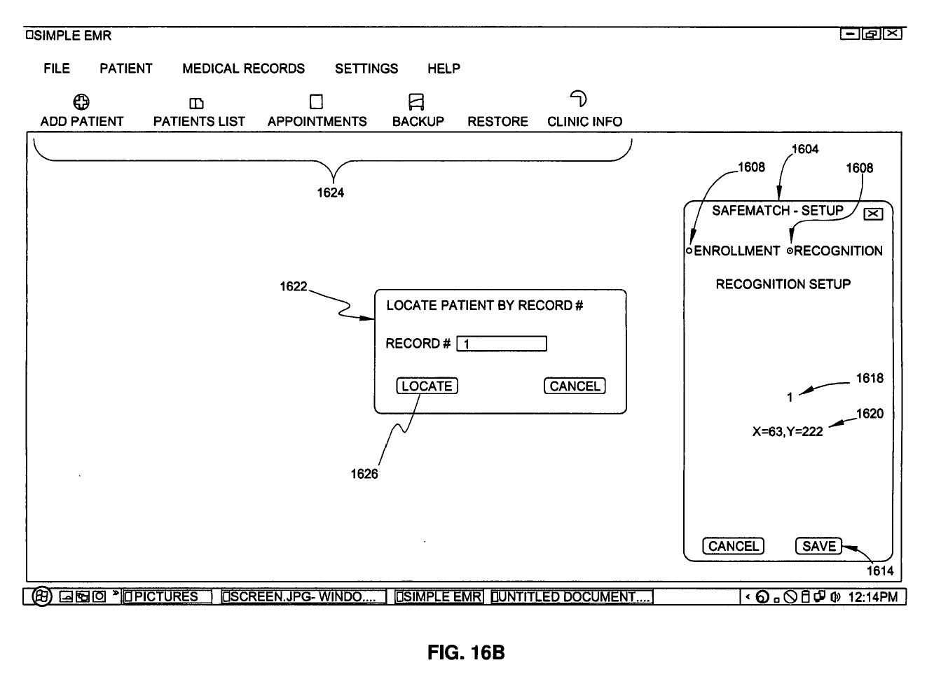

Referring again to FIG. 14, tightly integrated, seamless operation of the software applications in the workstation can be achieved if the authors of the applications requiring identification services modify their code to activate the identification service when needed. This can be facilitated by providing a software development kit, which may include documentation of identification service calls and operations, sample code, and test software that emulates the operation of the identification service 1416 to facilitate testing the application code without installation of the identification system on the development machine. As an alternative to this integrated operation, the identification service may be provided with a universal interface that responds to activation by the operating system's user interface 1424 in a predetermined manner. The operation of an exemplary universal interface will be described in more detail with reference to FIGS. 16a and 16b.

FIGS. 16a-b are illustrations of screen displays used in setup of an exemplary embodiment of a universal software interface that can be used with either iris or barcoding functions of the system described herein. The example will be explained in the context of iris identification functions. Referring first to FIG. 16a, interface software loaded on a Windows computer responds to user menu commands to initiate calls to the identification service for enrollment and/or identification functions. These operations may be activated in any desired manner, such as by assigned function keys or through a software menu.

In an embodiment, this approach uses windows messaging to directly get information on and interact with edit boxes, check boxes, list boxes, combos, buttons, and status bars. A combination of simulated keystrokes, mouse movement, and windows/control manipulation automates the task of interacting with a third party application.

In an embodiment, shown in FIG. 16a, the interface software places an icon 1602 in the Windows system tray. Double-clicking on this icon activates an iris identification function. Right clicking on the icon displays a menu offering identification, enrollment, and setup functions.

When setup is selected, window 1604 is displayed. Window 1604 can be toggled between enrollment and recognition setup functions using radio buttons 1608. When enrollment setup is selected as shown, the user activates a target window. In this example the user activates window 1606 from an electronic medical record system. Window 1606 displays a medical record for a person to be enrolled in the iris identification system. The medical record includes a record number (shown as “1”) in an area 1616. The user clicks on the target area 1616 in the target window. The setup application detects that the cursor has been removed from the setup window, and sends a message to the Windows system requesting information about the current cursor position. The Windows system returns the target window title, target area coordinates, and target area windows handle. The coordinates 1612 and the contents 1610 of the target area are displayed in setup window 1604 to indicate and confirm the user's target selection. This monitoring and display of position is repeated until the cursor returns to setup window 1604 and save button 1614 is clicked. Then, the target window title, target coordinates, and windows handle are stored in the registry. If multiple pieces of information (other than the record number) are required for enrollment, this process is repeated to select additional enrollment data items. This setup function instructs the system to look for the selected window when an enrollment function is requested, and obtain the subject's unique identifier from the indicated area for use in the enrollment process.

To set up the recognition function, the recognition button 1608 is clicked on the setup window 1604 as shown in FIG. 16b. The user operates the application's user interface 1624 to bring up the window 1622 where a subject's unique identifier should be inserted upon identification, and clicks on the target field in target window1622. In the example, the target field is the record number input field containing “1”. The software monitor cursor position, and if the cursor is not in the setup window, it sends a message to the Windows system requesting information about the current cursor position. The Windows system returns the target window title, target area coordinates, and target area windows handle. The setup application displays the selected area coordinates 1620 and the contents of the selected field at 1618. The position of the cursor is monitored and the display updated until the cursor returns to the setup window 1604. When the user clicks save button 1614, the setup application stores the target window title, target coordinates, and windows handle in the registry.

For the recognition setup function, additional options may be provided. In particular, it may be desirable to activate a menu selection or keystroke sequence to cause a lookup function, for example, to execute as soon as an identification is performed. An additional setup menu (not shown) is provided for the selection of posting actions. Functions available may include: select drop down item, enter static value, press search button, disable button, enable button, and any other desired functions to be performed after a field has been populated with the subject's unique identifier.

The recognition setup function may also allow the user to click on the target area in the target window to select a posting function provided in the target application, such as a button to be clicked or a menu item to be selected. In this case, when the cursor is out of the setup window, the software sends a message to the Windows system requesting information about the current cursor position. The Windows system returns the target window title, target area coordinates, target area windows handle. When the user returns the cursor to the setup window and clicks “done” the selected posting action is stored in the registry. Finally, the setup function may allow the user to specify that the recognition function should start up the target application if it is not already running If this option is desired, the user will indicate the application file location and the setup application will store this information in the registry.

Once these setup functions have been completed, operation of the universal interface proceeds as follows. When an enrollment is desired, the user right-clicks on the system tray icon and selects “Enrollment.” The system tray application reads the setup from the system registry and checks for presence of the preselected enrollment window. If the window is not present on the system, the application displays an error message. If the window is present, the universal interface sends a message through Windows messaging to the enrollment window, requesting the preselected enrollment data from the window. The application then calls the enrollment function in the identification service, passing the enrollment data obtained to the identification service. The enrollment process proceeds, storing iris pattern data and enrollment data in the database.

In an embodiment, a recognition process using the universal interface operates as follows. The user right clicks on the system tray icon to obtain the menu, and selects recognition. Alternatively the user can press a function key configured for that purpose, or double click on the system tray icon. The application reads the previous setup from the registry and checks to see whether the selected recognition window is present. If the window is not present and auto start up is enabled, the target application is started. If the window is not found and no auto start up has been configured, an error message is displayed.

The universal interface then calls the recognition function of the identification service. The iris recognition process proceeds, returning the stored identifier for the identified person (or if not found, returns an error). When the interface receives the identifier, it sends a message through windows messaging to the preselected recognition target window to post the identifier to the preselected target field in the window. If the setup provided additional posting actions, the universal interface sends messages through windows messaging to the recognition window to post the required selections (for example, select drop down menu items or press a button).

Thus, the universal interface makes it possible to use the disclosed identification system with almost any windows application, regardless of whether the author of the application is willing to integrate calls to the identification service into the application. The universal interface enrollment function will obtain the subject's unique identifier from a predetermined field in an application window and activate the enrollment function with that identifier. The universal interface's recognition function will activate the recognition function and deliver the resulting identifier to a predetermined target application and perform a record display or other function within that application.

A similar universal interface can be provided for the barcode functions of the present system. In an embodiment, a setup function similar to the recognition setup function is provided for barcode operation. A function key or other actuating method is configured to initiate a barcode operation. The actuating method may use a windows menu selection, a keyboard input, or may use the barcode trigger on the camera as an actuating step. A target window and field location are selected for delivery of the barcode data. When the barcode function is activated, either at the workstation or using the camera trigger, the universal interface software activates the barcode function of the system and delivers scanned barcode data to the desired target location.

A mirror can also be used on any of the housings to aid in aiming the device toward the eye.

The devices disclosed herein may also be mounted on a wall for access control applications, either using a cord or using a different wall mount housing. In some wall mount applications, the viewfinder may be omitted. The use of a higher resolution camera in conjunction with the wide-field eye locating methods described above is particularly advantageous in wall mounted and other self-ID applications.

In some embodiments, a more complex dual eye camera such as the LG 4000 or Iritech Neoris 2000 camera can be used for enrollment, while the low cost imager described herein is used for subsequent identifications.

Although illustrative embodiments have been described herein in detail, it should be noted and understood that the descriptions and drawings have been provided for purposes of illustration only and that other variations both in form and detail can be added thereupon without departing from the spirit and scope of the invention. The terms and expressions have been used as terms of description and not terms of limitation. Thus, the breadth and scope of the present invention should not be limited by any of the above-described exemplary embodiments, but should be defined only in accordance with the following claims and their equivalents. The terms or expressions herein should not be interpreted to exclude any equivalents of features shown and described or portions thereof.

1-14. (canceled)

15. A method of performing biometric iris identification of an operator and another person, comprising the steps of:
providing a handheld iris camera having a housing with at least one frontal surface and at least one rear surface opposite said frontal surface, an electronic imaging device in the housing, and at least one lens aligned to image a target iris onto said imaging device when said frontal surface faces a target eye;
performing self-identification by holding the camera to aim the frontal surface of the camera at the operator's own eye; and
performing identification of a person other than the operator by reversing the camera to aim the frontal surface of the camera at the target eye of said other person.

16. The method of claim 15 comprising the further step of providing one or more range indicators to be visible to the operator in both said self-identification step and said other person identification step.

17. The method of claim 15 including the further step of selectively providing the operator with access to a computer function based on said self-identification step.

18. The method of claim 15 including the further step of retrieving an electronic record for said person other than the operator following said step of identifying said person.

19. The method of claim 18 wherein the operator is a health care provider and said person other than the operator is a patient, comprising the further step of retrieving an electronic medical record in response to said step of identifying said person.

20. A handheld biometric iris identification camera, comprising:
a housing with at least one frontal surface and at least one rear surface opposite said frontal surface;
an electronic imaging device mounted in the housing;
at least one lens mounted in the housing and aligned to image a target iris onto said imaging device when said frontal surface faces a target eye;
a range indicator visible by an operator facing said rear surface while said frontal surface is facing the target eye, that changes states to indicate that the camera is in range of the target eye; and
an aiming aid visible from the target eye when said frontal surface faces the target eye.

21. The camera of claim 20 wherein said range indicator is also visible from the target eye when said frontal surface faces the target eye.

22. The camera of claim 20 wherein said range indicator comprises at least one LED indicator.

23. The camera of claim 22 wherein said range indicator comprises a plurality of LED indicators.

24. The camera of claim 20 wherein said aiming aid includes a mirror mounted in said frontal surface.

25. The camera of claim 24 wherein the mirror is positioned so that if the target eye is the operator's eye, and the operator can see the target eye in the mirror, said lens and imaging device will be aimed to image the target eye on the imaging device.

26. The camera of claim 20 further comprising a second aiming aid visible to an operator facing said rear surface when the frontal surface faces the target eye.

27. The camera of claim 26 wherein said second aiming aid includes an aperture through which the target iris can be seen by the operator.

28. The camera of claim 26 wherein said second aiming aid includes a mirror mounted in said rear surface.

29. The camera of claim 26 wherein said second aiming aid includes a sight for aligning the camera with the target iris.

30. The camera of claim 26 wherein the aiming aid is used during self-identification by a person facing the camera and the second aiming aid is used during identification of a person other than said operator.
